(19) United States
(12) Patent Application Publication
(10) Pub. No.: US 2026/0128228 A1
(43) Pub. Date: May 7, 2026

(54) THREE-TERMINAL MULTILAYER CERAMIC CAPACITOR

(71) Applicant: Murata Manufacturing Co., Ltd., Nagaokakyo-shi (JP)

(72) Inventor: Kentarou FUJIWARA, Nagaokakyo-shi (JP)

(21) Appl. No.: 19/439,820

(22) Filed: Jan. 5, 2026

Related U.S. Application Data
(63) Continuation of application No. PCT/JP2024/016303, filed on Apr. 25, 2024.

(30) Foreign Application Priority Data
Jul. 10, 2023 (JP) 2023-112813

(51) Int. Cl. H01G 4/30; H01G 4/012; H01G 4/232

(52) U.S. Cl. CPC H01G 4/30; H01G 4/012; H01G 4/2325

(57) ABSTRACT

In a three-terminal multilayer ceramic capacitor, each of third and fourth external electrodes includes a central portion having a thickness of about 3 μm or more, and first and second convex portions having a thickness greater than that of the central portion and located closer to first and second end surfaces than the central portion, and first and second limit points, adjacent to the first and second end surfaces, where, starting from first and second external electrode end portions on the side of the first and second end surfaces, a thickness is about 3 μm or more. Between the first and second limit points, first and second lead-out end portions, respectively of third and fourth lead-out electrode portions, are located.

### CROSS REFERENCE TO RELATED APPLICATIONS

This application claims the benefit of priority to Japanese Patent Application No. 2023-112813 filed on Jul. 10, 2023 and is a Continuation Application of PCT Application No. PCT/JP2024/016303 filed on Apr. 25, 2024. The entire contents of each application are hereby incorporated herein by reference.

### BACKGROUND OF THE INVENTION

### 1. Field of the Invention

The present invention relates to three-terminal multilayer ceramic capacitors.

### 2. Description of the Related Art

Japanese Unexamined Patent Application Publication No. 2018-46228 discloses a multilayer feedthrough ceramic capacitor having a general configuration, that is, a three-terminal multilayer ceramic capacitor. The three-terminal multilayer ceramic capacitor includes a multilayer body including a pair of main surfaces, a pair of lateral surfaces, and a pair of end surfaces, and external electrodes provided on an outer surface of the multilayer body. The multilayer body includes a stack of ceramic layers and internal electrode layers. The external electrode includes a pair of end surface electrodes provided on the pair of end surfaces, a portion of the pair of main surfaces, and a portion of the pair of lateral surfaces of the multilayer body, and a pair of lateral surface electrodes provided on a portion of the pair of lateral surfaces and a portion of the pair of main surfaces of the multilayer body. Each of the pair of lateral surface electrodes of Japanese Unexamined Patent Application Publication No. 2018-46228 includes a recessed portion in which the middle on the lateral surface is recessed toward the multilayer body. The recessed portion makes it possible to reduce the height of the swelling when the solder is applied. Therefore, it is possible for the solder fillet to be made small, and the restraining force received by the pair of lateral surface electrodes via the solder fillet is reduced. Therefore, the stress generated in the multilayer body is also reduced, such that it is possible to reduce or prevent the occurrence of cracks in the multilayer body.

However, Japanese Unexamined Patent Application Publication No. 2018-46228 does not disclose any positional relationship between the lateral surface electrodes and the internal electrode layers. When the internal electrode layers are provided so as to be misaligned with respect to the lateral surface electrodes, for example, a portion of the internal electrode layers may be positioned outside the lateral surface electrodes. In this case, moisture or the like infiltrates into the multilayer body from a portion of the internal electrode layer that is not covered with the lateral surface electrode, and the moisture resistance reliability of the three-terminal multilayer ceramic capacitor deteriorates.

### SUMMARY OF THE INVENTION

Example embodiments of the present invention provide three-terminal multilayer ceramic capacitors each with improved moisture resistance reliability.

An example embodiment of the present invention provides a three-terminal multilayer ceramic capacitor which includes a multilayer body including a plurality of ceramic layers and a plurality of internal electrode layers that are laminated, a first main surface and a second main surface opposed to each other in a height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction, and a plurality of external electrodes. The plurality of internal electrode layers include a plurality of first internal electrode layers each extending toward the first end surface and the second end surface, and a plurality of second internal electrode layers each extending toward the first lateral surface and the second lateral surface. The plurality of external electrodes include a first external electrode on the first end surface and connected to the plurality of first internal electrode layers, a second external electrode on the second end surface and connected to the plurality of first internal electrode layers, a third external electrode on the first lateral surface and connected to the plurality of second internal electrode layers, and a fourth external electrode on the second lateral surface and connected to the plurality of second internal electrode layers. The plurality of first internal electrode layers each include a first counter electrode portion opposed to a corresponding one of the plurality of second internal electrode layers, a first extension electrode portion extending from the first counter electrode portion toward the first end surface, and a second extension electrode portion extending from the first counter electrode portion toward the second end surface. The plurality of second internal electrode layers each include a second counter electrode portion opposed to a corresponding one of the plurality of first counter electrode portions, a third extension electrode portion extending from the second counter electrode portion toward the first lateral surface, and a fourth extension electrode portion extending from the second counter electrode portion toward the second lateral surface. In a cross-sectional view along the first main surface and the second main surface, each of the third external electrode and the fourth external electrode includes a middle portion having a thickness of about 3 un or more in the width direction with respect to each of the first lateral surface and the second lateral surface and located at a middle in the length direction, a first protruding portion having a thickness in the width direction with respect to each of the first lateral surface and the second lateral surface larger than a thickness in the width direction of the middle portion and located closer to the first end surface than the middle portion, a second protruding portion having a thickness in the width direction with respect to each of the first lateral surface and the second lateral surface larger than a thickness in the width direction of the middle portion and located closer to the second end surface than the middle portion, a first limit point adjacent to the first end surface and having a thickness in the width direction with respect to each of the first lateral surface and the second lateral surface of about 3 μm or more from a first external electrode end portion adjacent to the first end surface, and a second limit point adjacent to the second end surface side and having a thickness in the width direction with respect to each of the first lateral surface and the second lateral surface of about 3 μm or more from a second external electrode end portion adjacent to the second end surface. A first extension end portion adjacent to the first end surface and a second extension end portion adjacent to the second end surface of each of the third extension electrode portion and the fourth extension electrode portion are located between the first limit point and the second limit point.

According to the above-described configuration, the third and fourth external electrodes including the first and second protruding portions have a large thickness in a range of about 3 μm or more. Therefore, since a tolerance for misalignment of the second internal electrode layer with respect to the third and fourth external electrodes is large, it is possible to improve the moisture resistance reliability.

According to example embodiments of the present invention, three-terminal multilayer ceramic capacitors each with improved moisture resistance reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an example of a three-terminal multilayer ceramic capacitor according to an example embodiment of the present invention.

FIG. 2 is a top view showing an example of a three-terminal multilayer ceramic capacitor according to an example embodiment of the present invention.

FIG. 3 is a front view showing an example of a three-terminal multilayer ceramic capacitor according to an example embodiment of the present invention.

FIG. 4 is a cross-sectional view taken along the line IV-IV in FIG. 1.

FIG. 5 is a cross-sectional view taken along the line V-V in FIG. 1.

FIG. 6 is a cross-sectional view taken along the line VI-VI in FIG. 4.

FIG. 7 is a cross-sectional view taken along the line VII-VII in FIG. 4.

FIG. 8 is an enlarged photograph of a portion a in FIG. 7.

FIG. 9 is an enlarged schematic view of the portion a of FIG. 7, showing a state of a protruding portion and dimensions of each portion.

FIG. 10 is an enlarged schematic view of the portion a of FIG. 7 and is a view showing a bonding state between a third external electrode and a third extension electrode portion.

FIG. 11A is a process diagram showing a first application step of applying a first paste layer to a multilayer body.

FIG. 11B is a process diagram showing a second application step of applying a second paste layer to the multilayer body.

FIG. 12 is a schematic view for explaining a difference in configuration between a three-terminal multilayer ceramic capacitor according to an example embodiment of the present invention and an existing three-terminal multilayer ceramic capacitor.

### DETAILED DESCRIPTION OF THE EXAMPLE EMBODIMENTS

Example embodiments of the present invention will be described in detail below with reference to the drawings.

Three-terminal multilayer ceramic capacitors according to example embodiments of the present invention will be described.

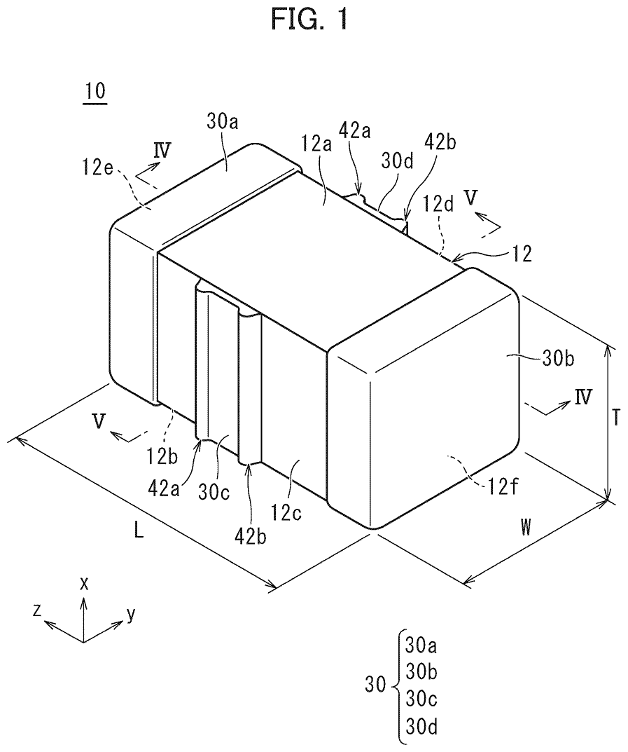

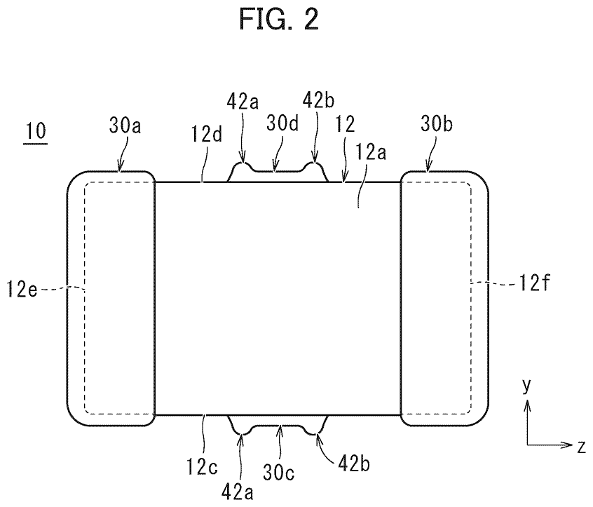

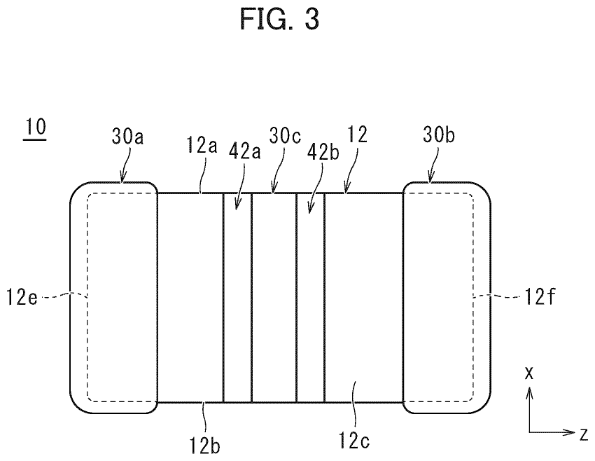

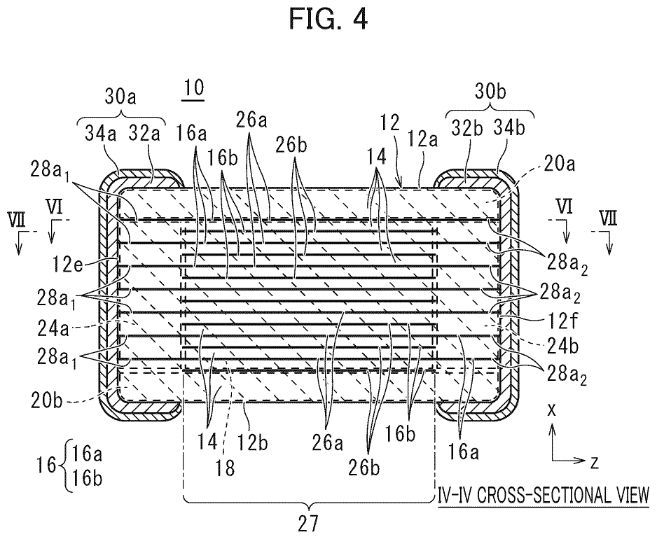

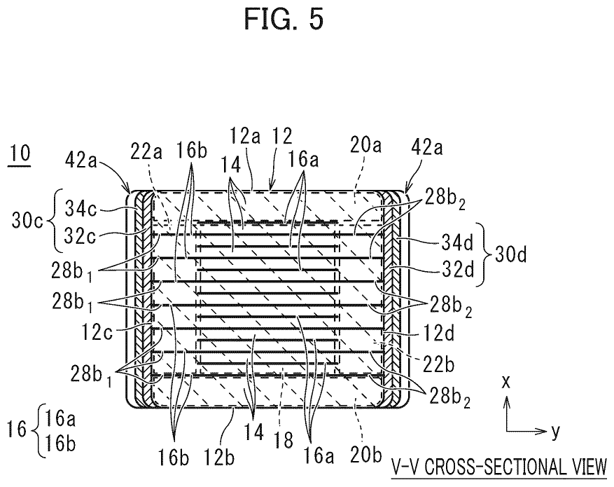

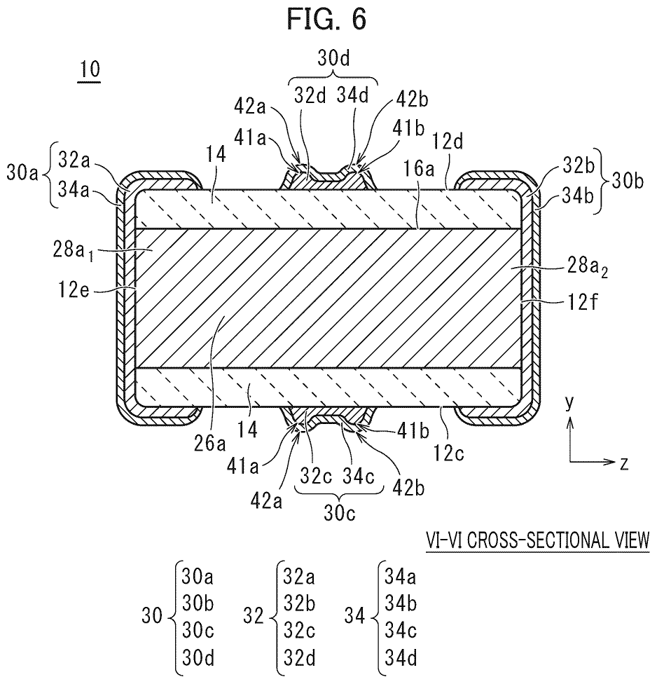

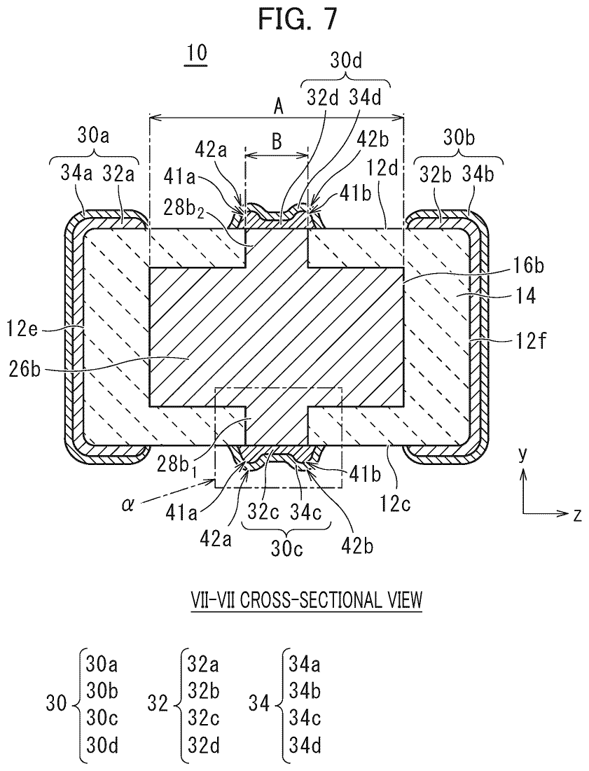

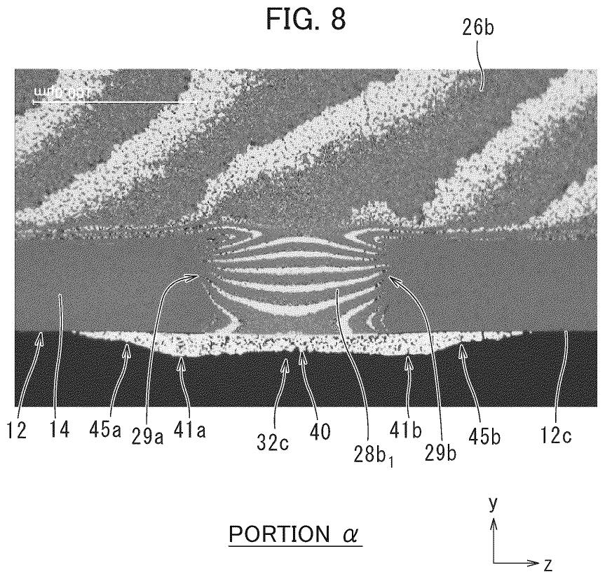

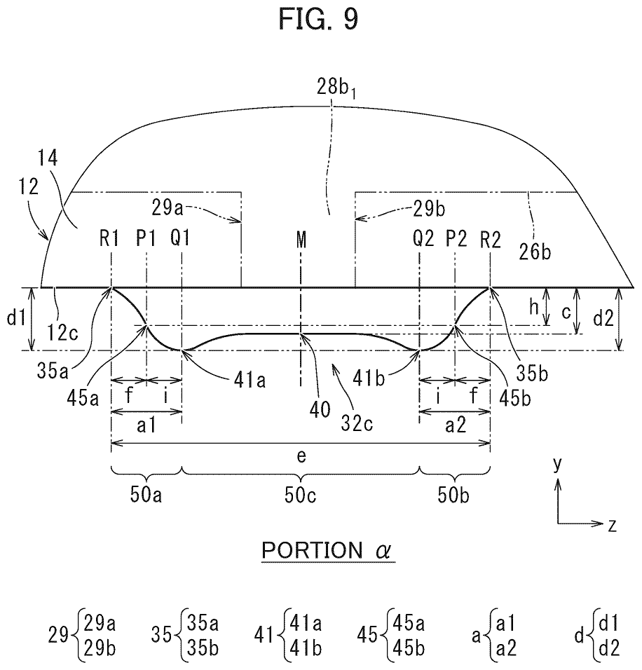

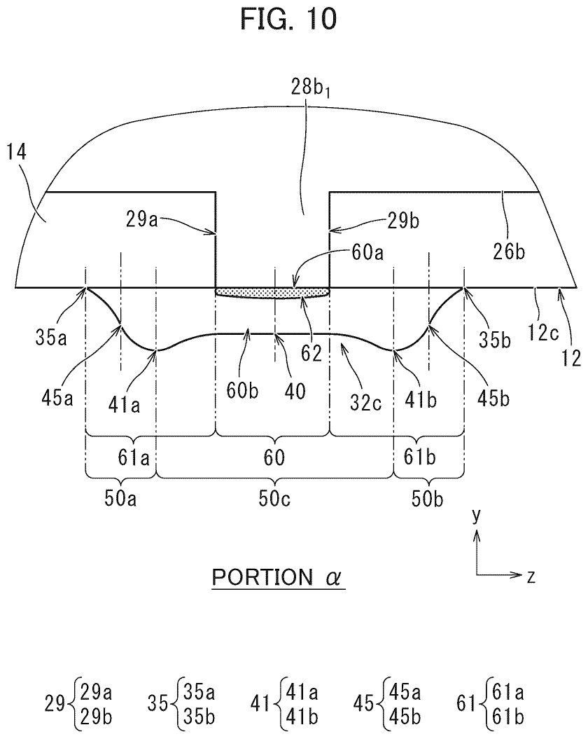

FIG. 1 is an external perspective view showing an example of a three-terminal multilayer ceramic capacitor according to an example embodiment of the present invention. FIG. 2 is a top view showing an example of a three-terminal multilayer ceramic capacitor according to an example embodiment of the present invention. FIG. 3 is a front view showing an example of a three-terminal multilayer ceramic capacitor according to an example embodiment of the present invention. FIG. 4 is a cross-sectional view taken along the line IV-IV in FIG. 1. FIG. 5 is a cross-sectional view taken along the line V-V in FIG. 1. FIG. 6 is a cross-sectional view taken along the line VI-VI in FIG. 4. FIG. 7 is a cross-sectional view taken along the line VII-VII in FIG. 4. FIG. 8 is an enlarged photograph of a portion a in FIG. 7. FIG. 9 is an enlarged schematic view of the portion a of FIG. 7 and is a diagram showing a state of a protruding portion and dimensions of each portion. FIG. 10 is an enlarged schematic view of the portion a of FIG. 7 and is a view showing a bonding state between a third external electrode and a third extension electrode portion.

As shown in FIG. 1, a three-terminal multilayer ceramic capacitor 10 includes, for example, a rectangular or substantially rectangular parallelepiped multilayer body 12 and external electrodes 30.

The multilayer body 12 includes a plurality of laminated ceramic layers 14 and a plurality of laminated internal electrode layers 16, each on a corresponding one of the plurality of ceramic layers 14. The ceramic layers 14 and the internal electrode layers 16 are laminated in the height direction x.

The multilayer body 12 includes a first main surface 12a and a second main surface 12b opposed to each other in the height direction x, a first lateral surface 12c and a second lateral surface 12d opposed to each other in the width direction y orthogonal or substantially orthogonal to the height direction x, and a first end surface 12e and a second end surface 12f opposed to each other in the length direction z orthogonal or substantially orthogonal to the height direction x and the width direction y. The multilayer body 12 includes rounded corner portions and rounded ridge portions. In addition, the corner portion refers to a portion where three adjacent surfaces of the multilayer body intersect, and the ridge portion refers to a portion where two adjacent surfaces of the multilayer body intersect. In addition, unevenness and the like may be provided on a portion or all of the first main surface 12a and the second main surface 12b, the first lateral surface 12c and the second lateral surface 12d, and the first end surface 12e and the second end surface 12f. In addition, the dimension L of the multilayer body 12 in the length direction z is not necessarily longer than the dimension W in the width direction y.

The multilayer body 12 includes an inner layer portion 18, and a first main surface-side outer layer portion 20a and a second main surface-side outer layer portion 20b that sandwich the inner layer portion 18 in the lamination direction.

The inner layer portion 18 includes a plurality of ceramic layers 14 and a plurality of internal electrode layers 16. The inner layer portion 18 includes an internal electrode layer 16 located closest to the first main surface 12a to an internal electrode layer 16 located closest to the second main surface 12b in the lamination direction. The internal electrode layers 16 include first internal electrode layers 16a each extending toward the first end surface 12e and the second end surface 12f, and second internal electrode layers 16b each extending toward the first lateral surface 12c and the second lateral surface 12d. In the inner layer portion 18, a plurality of the first internal electrode layers 16a and a plurality of the second internal electrode layers 16b are opposed to each other with a corresponding one of the ceramic layers 14 interposed therebetween. The inner layer portion 18 is a portion that generates capacitance and substantially defines and functions as a capacitor.

The first main surface-side outer layer portion 20a is located adjacent to the first main surface 12a, and includes a plurality of ceramic layers 14 located between the first main surface 12a, and the outermost surface of the inner layer portion 18 adjacent to the first main surface 12a and one straight line of the outermost surface (an extension line from the outermost surface to the first lateral surface 12c, the second lateral surface 12d, the first end surface 12e, and the second end surface 12f). That is, the first main surface-side outer layer portion 20a is an aggregate of the plurality of ceramic layers 14 located between the first main surface 12a and the internal electrode layer 16 closest to the first main surface 12a. The ceramic layers 14 used in the first main surface-side outer layer portion 20a may be the same or substantially the same as the ceramic layers 14 used in the inner layer portion 18. Similarly, the second main surface-side outer layer portion 20b includes a plurality of ceramic layers 14 located adjacent to the second main surface 12b and located between the second main surface 12b, and the outermost surface of the inner layer portion 18 adjacent to the second main surface 12b and one straight line of the outermost surface (an extension line from the outermost surface to the first lateral surface 12c, the second lateral surface 12d, the first end surface 12e, and the second end surface 12f). That is, the second main surface-side outer layer portion 20b is an aggregate of the plurality of ceramic layers 14 located between the second main surface 12b and the internal electrode layer 16 closest to the second main surface 12b. The ceramic layers 14 used in the second main surface-side outer layer portion 20b may be the same or substantially the same as the ceramic layers 14 used in the inner layer portion 18.

In addition, the multilayer body 12 includes a first lateral surface-side outer layer portion 22a which is located adjacent to the first lateral surface 12c and includes a plurality of ceramic layers 14 located between the first lateral surface 12c and the outermost surface of the inner layer portion 18 adjacent to the first lateral surface 12c. Similarly, the multilayer body 12 includes a second lateral surface-side outer layer portion 22b which is located adjacent to the second lateral surface 12d and includes a plurality of ceramic layers 14 located between the second lateral surface 12d and the outermost surface of the inner layer portion 18 adjacent to the second lateral surface 12d. In addition, the first lateral surface-side outer layer portion 22a and the second lateral surface-side outer layer portion 22b are also referred to as W gaps or side gaps.

Further, the multilayer body 12 includes a first end surface-side outer layer portion 24a which is located adjacent to the first end surface 12e and includes a plurality of ceramic layers 14 located between the first end surface 12e and the outermost surface of the inner layer portion 18 adjacent to the first end surface 12e. Similarly, the multilayer body 12 includes a second end surface-side outer layer portion 24b which is located adjacent to the second end surface 12f and includes a plurality of ceramic layers 14 located between the second end surface 12f and the outermost surface of the inner layer portion 18 adjacent to the second end surface 12f. In addition, the first end surface-side outer layer portion 24a and the second end surface-side outer layer portion 24b are also referred to as L gaps or end gaps.

The dimensions of the multilayer body 12 are not particularly limited.

The ceramic layers 14 can be made of, for example, a dielectric material as the ceramic material. As such a dielectric material, for example, dielectric ceramic including a component such as BaTiO₃, CaTiO₃, SrTiO₃, or CaZrO₃ can be used. In a case where the dielectric material is included as a main component, a subcomponent having a lower content than the main component, such as, for example, a Mn compound, a Fe compound, a Cr compound, a Co compound, or a Ni compound, may be added according to the desired characteristics of the multilayer body 12.

The thickness of each ceramic layer 14 after firing is preferably, for example, about 0.3 μm or more and about 5.0 μm or less. The number of laminated ceramic layers 14 is preferably, for example, 5 or more and 2000 or less. In addition, the number of the ceramic layers 14 is the total number of the number of the ceramic layers 14 of the inner layer portion 18 and the number of the ceramic layers 14 of the first main surface-side outer layer portion 20a and the second main surface-side outer layer portion 20b.

The multilayer body 12 includes a plurality of the first internal electrode layers 16a and a plurality of the second internal electrode layers 16b as the plurality of internal electrode layers 16. The plurality of first internal electrode layers 16a are provided on the plurality of ceramic layers 14 and extend toward the first end surface 12e and the second end surface 12f. The plurality of second internal electrode layers 16b are provided on the plurality of ceramic layers 14 and extend toward the first lateral surface 12c and the second lateral surface 12d. The plurality of first internal electrode layers 16a and the plurality of second internal electrode layers 16b may be alternately laminated via a corresponding one of the ceramic layers 14, or after a plurality of ceramic layers 14 in which the first internal electrode layers 16a are provided are laminated, the ceramic layers 14 in which the second internal electrode layers 16b are provided may be laminated. In this way, it is possible to change the lamination pattern according to the desired capacitance value.

As shown in FIG. 6, each of the first internal electrode layers 16a includes a first counter electrode portion 26a opposed to the second internal electrode layers 16b, a first extension electrode portion 28a₁ extending from the first counter electrode portion 26a toward the surface of the first end surface 12e of the multilayer body 12, and a second extension electrode portion 28a₂ extending from the first counter electrode portion 26a toward the surface of the second end surface 12f of the multilayer body 12. Specifically, the first extension electrode portion 28a₁ is exposed on the surface of the first end surface 12e of the multilayer body 12, and the second extension electrode portion 28a₂ is exposed on the surface of the second end surface 12f of the multilayer body 12. Therefore, each of the first internal electrode layers 16a is not exposed on the surfaces of the first lateral surface 12c or the second lateral surface 12d of the multilayer body 12. The first extension electrode portion 28a₁ is connected to the first external electrode 30a, and the second extension electrode portion 28a₂ is connected to the second external electrode 30b.

The shape of the first counter electrode portion 26a and the shapes of the first extension electrode portion 28a₁ and the second extension electrode portion 28a₂ are not particularly limited, but are preferably rectangular or substantially rectangular. However, the corner portions may be rounded.

In addition, the lengths of the first extension electrode portion 28a₁ and the second extension electrode portion 28a₂ in the width direction y may be equal to or shorter than the length of the first counter electrode portion 26a in the width direction y. In addition, the shapes of the first extension electrode portion 28a₁ and the second extension electrode portion 28a₂ may be tapered.

As shown in FIG. 7, each of the second internal electrode layers 16b has a substantially cross shape, and includes a second counter electrode portion 26b opposed to the first counter electrode portion 26a, a third extension electrode portion 28b₁ extending from the second counter electrode portion 26b toward the surface of the first lateral surface 12c of the multilayer body 12, and a fourth extension electrode portion 28b₂ extending from the second counter electrode portion 26b toward the surface of the second lateral surface 12d of the multilayer body 12. Specifically, the third extension electrode portion 28b₁ is exposed on the surface of the first lateral surface 12c of the multilayer body 12, and the fourth extension electrode portion 28b₂ is exposed on the surface of the second lateral surface 12d of the multilayer body 12. Therefore, the second internal electrode layer 16b is not exposed on the surface of the first end surface 12e or the surface of the second end surface 12f of the multilayer body 12. The third extension electrode portion 28b₁ is connected to the third external electrode 30c, and the fourth extension electrode portion 28b2 is connected to the fourth external electrode 30d.

The shape of the second counter electrode portion 26b and the shapes of the third extension electrode portion 28b₁ and the fourth extension electrode portion 28b2 are preferably rectangular or substantially rectangular. However, the corner portions may be rounded.

The relationship between the dimension A in the length direction z between the side of the second counter electrode portion 26b adjacent to the first end surface 12e and the side adjacent to the second end surface 12f and the dimension B in the length direction z between the side adjacent to the first end surface 12e and the side adjacent to the second end surface 12f of the third extension electrode portion 28b₁ and the fourth extension electrode portion 28b2 is preferably A≥B.

The shape of the third extension electrode portion 28b₁ may be a tapered shape having a narrower width as it approaches the first lateral surface 12c, and the shape of the fourth extension electrode portion 28b₂ may be a tapered shape having a narrower width as it approaches the second lateral surface 12d.

In addition, the multilayer body 12 includes a counter electrode portion region 27. The counter electrode portion region 27 refers to a portion where the first counter electrode portion 26a of the first internal electrode layer 16a and the second counter electrode portion 26b of the second internal electrode layer 16b are opposed to each other. The counter electrode portion region 27 is configured as a portion of the inner layer portion 18. In addition, the counter electrode portion region 27 is also referred to as a capacitor effective portion.

It is possible to configure the first internal electrode layers 16a and the second internal electrode layers 16b of a suitable electrically conductive material such as, for example, a metal including Ni as a main component, such as Cu, Ag, Pd, or Au, or an alloy including at least one of these metals, such as an Ag—Pd alloy.

The number of the first internal electrode layers 16a and the second internal electrode layers 16b is not particularly limited, but is preferably, for example, 10 or more and 2000 or less in total.

The thickness of each first internal electrode layer 16a is not particularly limited, but is preferably, for example, about 0.30 μm or more and about 1.0 μm or less. The thickness of each second internal electrode layer 16b is not particularly limited, but is preferably, for example, about 0.30 μm or more and about 1.0 μm or less.

The external electrodes 30 are provided on the first end surface 12e and the second end surface 12f, the first lateral surface 12c and the second lateral surface 12d, and the first main surface 12a and the second main surface 12b of the multilayer body 12.

The external electrodes 30 include a first external electrode 30a, a second external electrode 30b, a third external electrode 30c, and a fourth external electrode 30d.

The first external electrode 30a is connected to the first internal electrode layers 16a and is provided on the surface of the first end surface 12e. In addition, in the present example embodiment, the first external electrode 30a extends from the first end surface 12e of the multilayer body 12 and is also provided on a portion of the first main surface 12a and a portion of the second main surface 12b, and a portion of the first lateral surface 12c and a portion of the second lateral surface 12d. In this case, the first external electrode 30a is electrically connected to the first extension electrode portions 28a₁ of the first internal electrode layers 16a. In addition, the first external electrode 30a may be provided only on the surface of the first end surface 12e.

The second external electrode 30b is connected to the first internal electrode layers 16a and is provided on the surface of the second end surface 12f. In addition, in the present example embodiment, the second external electrode 30b extends from the second end surface 12f of the multilayer body 12 and is also provided on a portion of the first main surface 12a and a portion of the second main surface 12b, and a portion of the first lateral surface 12c and a portion of the second lateral surface 12d. In this case, the second external electrode 30b is electrically connected to the second extension electrode portions 28a₂ of the first internal electrode layers 16a. In addition, the second external electrode 30b may be provided only on the surface of the second end surface 12f.

The third external electrode 30c is connected to the second internal electrode layers 16b and is provided on the surface of the first lateral surface 12c. The third external electrode 30c is electrically connected to the third extension electrode portions 28b₁ of the second internal electrode layers 16b. In addition, the third external electrode 30c may extend from the first lateral surface 12c of the multilayer body 12 and also be provided on a portion of the first main surface 12a and a portion of the second main surface 12b. As described later, since the third base electrode layer 32c includes a first protruding portion (an example of a first protruding portion) 41a and a second protruding portion (an example of a second protruding portion) 41b, the third external electrode 30c of the present example embodiment includes a first outer protruding portion (an example of a first protruding portion) 42a and a second outer protruding portion (an example of a second protruding portion) 42b along the shape of the third base electrode layer 32c.

The fourth external electrode 30d is connected to the second internal electrode layers 16b and is provided on the surface of the second lateral surface 12d. The fourth external electrode 30d is electrically connected to the fourth extension electrode portions 28b2 of the second internal electrode layers 16b. In addition, the fourth external electrode 30d may extend from the second lateral surface 12d of the multilayer body 12 and also be provided on a portion of the first main surface 12a and a portion of the second main surface 12b. As described later, since the fourth base electrode layer 32d includes a first protruding portion (an example of a first protruding portion) 41a and a second protruding portion (an example of a second protruding portion) 41b, the fourth external electrode 30d of the present example embodiment includes a first outer protruding portion (an example of a first protruding portion) 42a and a second outer protruding portion (an example of a second protruding portion) 42b along the shape of the fourth base electrode layer 32d.

In the multilayer body 12, the first counter electrode portion 26a of the first internal electrode layers 16a and the second counter electrode portion 26b of the second internal electrode layers 16b are opposed to each other with the ceramic layers 14 interposed therebetween, such that capacitance is generated. Therefore, it is possible to obtain capacitance between the first external electrode 30a and the second external electrode 30b to which the first internal electrode layers 16a are connected, and the third external electrode 30c and the fourth external electrode 30d to which the second internal electrode layers 16b are connected, such that characteristics of the capacitor are provided.

The external electrodes 30 each include a base electrode layer 32 including a metal component and a glass component, and a plated layer 34 provided on a surface of the base electrode layer 32.

The base electrode layer 32 includes a first base electrode layer 32a, a second base electrode layer 32b, a third base electrode layer 32c, and a fourth base electrode layer 32d.

The first base electrode layer 32a is connected to the first internal electrode layers 16a and is provided on the surface of the first end surface 12e. In addition, the first base electrode layer 32a extends from the first end surface 12e and is also provided on a portion of the first main surface 12a and a portion of the second main surface 12b, and a portion of the first lateral surface 12c and a portion of the second lateral surface 12d. In addition, the first base electrode layer 32a may be provided only on the surface of the first end surface 12e. The second base electrode layer 32b is connected to the first internal electrode layers 16a and is provided on the surface of the second end surface 12f. In addition, the second base electrode layer 32b extends from the second end surface 12f and is also provided on a portion of the first main surface 12a and a portion of the second main surface 12b, and a portion of the first lateral surface 12c and a portion of the second lateral surface 12d. In addition, the second base electrode layer 32b may be provided only on the surface of the second end surface 12f.

The third base electrode layer 32c is connected to the second internal electrode layers 16b and is provided on the surface of the first lateral surface 12c. In addition, the third base electrode layer 32c may extend from the first lateral surface 12c and be also provided on a portion of the first main surface 12a and a portion of the second main surface 12b. The fourth base electrode layer 32d is connected to the second internal electrode layers 16b and is provided on the surface of the second lateral surface 12d. In addition, the fourth base electrode layer 32d may extend from the second lateral surface 12d and be also provided on a portion of the first main surface 12a and a portion of the second main surface 12b.

Each of the third and fourth base electrode layers 32c and 32d in the present example embodiment includes the protruding portion 41 including the first protruding portion 41a and the second protruding portion 41b as shown in FIGS. 6 to 10. Characteristic shapes of the third and fourth base electrode layers 32c and 32d of the present example embodiment will be described later in detail.

The base electrode layer 32 includes at least one of, for example, a fired layer, an electrically conductive resin layer, or the like. In addition, in the Experimental Examples described later, the base electrode layer 32 is a fired layer. Hereinafter, each configuration in the case where the base electrode layer 32 is the fired layer or electrically conductive resin layer will be described.

The fired layer includes a glass component and a metal component. The glass component of the fired layer includes at least one of, for example, B, Si, Ba, Mg, Al, Li, or the like. As the metal component of the fired layer, for example, Cu is a main component, and at least one of Ni, Ag, Pd, an Ag—Pd alloy, Au, or the like is included. The fired layer is formed by applying an electrically conductive paste including a glass component and a metal component to the multilayer body 12, and firing the paste. The fired layer may be formed by simultaneously firing the multilayer chip having the internal electrode layers 16 and the ceramic layers 14 and the electrically conductive paste applied to the multilayer chip, or may be formed by firing the multilayer chip having the internal electrode layers 16 and the ceramic layers 14 to obtain the multilayer body 12, and then firing the electrically conductive paste on the multilayer body 12. In addition, when the multilayer chip including the internal electrode layers 16 and the ceramic layers 14 and the electrically conductive paste applied to the multilayer chip are fired at the same time, it is preferable that the fired layer is formed by firing a material to which a dielectric material is added instead of a glass component. The fired layer may include a plurality of layers.

In addition, when the base electrode layer 32 includes a dielectric material instead of a glass component, it is possible to improve the adhesion between the multilayer body 12 and the base electrode layer 32. In addition, the base electrode layer 32 may include both a glass component and a dielectric component.

As the dielectric material included in the base electrode layer 32, the same type of dielectric material as the ceramic layers 14 may be used, or a different type of dielectric material may be used. The dielectric component includes, for example, at least one of BaTiO₃, CaTiO₃, (Ba, Ca)TiO₃, SrTiO₃, CaZrO₃, or the like.

When the electrically conductive resin layer is provided as the base electrode layer 32, the electrically conductive resin layer may be provided on the fired layer so as to cover the fired layer, or may be provided directly on the multilayer body 12 without providing the fired layer. The electrically conductive resin layer includes a metal such as electrically conductive particles and a thermosetting resin. The electrically conductive resin layer may completely cover the base electrode layer or may partially cover the base electrode layer.

Since the electrically conductive resin layer includes a thermosetting resin, the electrically conductive resin layer is more flexible than an electrically conductive layer made of, for example, a plating film or a fired product of an electrically conductive paste. For this reason, even when a physical shock or a shock due to a thermal cycle is applied to the three-terminal multilayer ceramic capacitor 10, the electrically conductive resin layer functions as a buffer layer, and it is possible to reduce or prevent cracks in the three-terminal multilayer ceramic capacitor 10.

As the metal included in the electrically conductive resin layer, it is possible to use, for example, Ag, Ni, Sn, Bi, or an alloy including Cu as a main component. In addition, for example, it is also possible to use a metal powder obtained by coating the surface of the metal powder with Ag. When an Ag-coated metal powder is used, it is preferable to use, for example, Cu, Ni, Sn, Bi, or an alloy powder thereof as the metal powder. The reason why the electrically conductive metal powder of Ag is used as the electrically conductive metal is that Ag is suitable for an electrode material because it has the lowest specific resistance among metals, and Ag is a noble metal and thus will not oxidize and has high weather resistance. This is because it is possible to make the metal of the base material inexpensive while maintaining the above-described characteristics of Ag.

Further, for example, as the metal included in the electrically conductive resin layer, it is also possible to use a metal obtained by subjecting Cu or Ni to an antioxidant treatment. In addition, as the metal included in the electrically conductive resin layer, it is also possible to use a metal powder obtained by coating the surface of the metal powder with, for example, Sn, Ni, or Cu. When a metal powder coated with Sn, Ni, or Cu is used, it is preferable to use, for example, Ag, Cu, Ni, Sn, Bi, or an alloy powder thereof as the metal powder.

The metal included in the electrically conductive resin layer mainly defines and functions to provide the electrical conductivity of the electrically conductive resin layer. Specifically, when the electrically conductive fillers are in contact with each other, a conduction path is provided inside the electrically conductive resin layer.

As the metal included in the electrically conductive resin layer, for example, it is possible to use a metal having a spherical shape, a metal having a flat shape, or the like, and it is preferable to use a mixture of a spherical metal powder and a flat metal powder.

As the resin of the electrically conductive resin layer, for example, it is possible to use various known thermosetting resins such as an epoxy resin, a phenoxy resin, a phenol resin, a urethane resin, a silicone resin, or a polyimide resin. Among them, an epoxy resin excellent in heat resistance, moisture resistance, adhesion, and the like is one of the preferable resins.

In addition, the electrically conductive resin layer preferably includes a curing agent together with a thermosetting resin. When an epoxy resin is used as the base resin, it is possible to use various known compounds such as, for example, phenol-based, amine-based, acid anhydride-based, imidazole-based, active ester-based, or amide-imide-based compounds as the curing agent of the epoxy resin.

The electrically conductive resin layer may include a plurality of layers.

The plated layer 34 includes a first plated layer 34a, a second plated layer 34b, a third plated layer 34c, and a fourth plated layer 34d. The first plated layer 34a, the second plated layer 34b, the third plated layer 34c, and the fourth plated layer 34d, which are the plated layers 34 that can be provided on the base electrode layer 32, will be described with reference to FIGS. 4 and 5. The first plated layer 34a, the second plated layer 34b, the third plated layer 34c, and the fourth plated layer 34d include, for example, at least one of Cu, Ni, Sn, Ag, Pd, an Ag—Pd alloy, Au, or the like.

The first plated layer 34a is provided so as to cover the first base electrode layer 32a. The second plated layer 34b is provided so as to cover the second base electrode layer 32b. The third plated layer 34c is provided so as to cover the third base electrode layer 32c. The fourth plated layer 34d is provided so as to cover the fourth base electrode layer 32d.

As shown in FIGS. 6 and 7, each of the third and fourth plated layers 34c and 34d includes an outer protruding portion 42 corresponding to the protruding portion 41 of each of the third and fourth base electrode layers 32c and 32d. That is, each of the third and fourth plated layers 34c and 34d includes the first outer protruding portion 42a and the second outer protruding portion 42b along the shapes of the first protruding portion 41a and the second protruding portion 41b of the third and fourth base electrode layers 32c. Since the third and fourth plated layers 34c and 34d provide the outer surfaces of the third and fourth external electrodes 30c and 30d, the first and second outer protruding portions 42a and 42b of the third and fourth plated layers 34c and 34d function as the first and second outer protruding portions 42a and 42b of the third and fourth external electrodes 30c and 30d.

The first plated layer 34a, the second plated layer 34b, the third plated layer 34c, and the fourth plated layer 34d may include a plurality of layers. In this case, it is preferable that the plated layer 34 has a two-layer configuration including, for example, a lower plated layer provided on the base electrode layer 32 by Ni plating and an upper plated layer provided on the lower plated layer by Sn plating.

That is, the first plated layer 34a includes a first lower plated layer and a first upper plated layer located on the surface of the first lower plated layer. In addition, the second plated layer 34b includes a second lower plated layer and a second upper plated layer located on the surface of the second lower plated layer. Similarly, the third plated layer 34c includes a third lower plated layer and a third upper plated layer located on the surface of the third lower plated layer. In addition, the fourth plated layer 34d includes a fourth lower plated layer and a fourth upper plated layer located on the surface of the fourth lower plated layer.

The lower plated layer formed by Ni plating is used to reduce or prevent the base electrode layer 32 from being eroded by solder when the three-terminal multilayer ceramic capacitor 10 is mounted, and the upper plated layer formed by Sn plating is used to improve the wettability of solder when the three-terminal multilayer ceramic capacitor 10 is mounted and to facilitate mounting. The thickness per one plated layer is preferably, for example, about 2.0 μm or more and about 15.0 μm or less.

Next, the shapes of the third and fourth base electrode layers 32c and 32d will be further described. Since the third and fourth base electrode layers 32c and 32d have the same or substantially the same shape, the third base electrode layer 32c will be described, and the description of the fourth base electrode layer 32d will be omitted or simplified. FIGS. 8 to 10 show cross-sectional shapes of the multilayer body 12 and the third base electrode layer 32c in a cross-sectional view along the first and second main surfaces 12a and 12b. FIGS. 8 to 10 show an LW cross section (a cross section including the length direction z and the width direction y) at ½T, for example, when the dimension of the three-terminal multilayer ceramic capacitor 10 in the height direction x is T.

As shown in FIGS. 8 to 10, the third base electrode layer 32c is provided on the first lateral surface 12c of the multilayer body 12 in the LW cross section. The third base electrode layer 32c includes a middle portion 40 and protruding portions 41. The middle portion 40 is a portion of the third base electrode layer 32c located at a point M which is located in the middle in the length direction z of the third base electrode layer 32c, and the thickness in the width direction y with respect to the first lateral surface 12c is, for example, about 3 μm or more. The protruding portions 41 include the first protruding portion 41a and the second protruding portion 41b.

The first protruding portion 41a is a portion in which the thickness in the width direction y with respect to the first lateral surface 12c is larger than that of the middle portion 40, and is a portion of the third base electrode layer 32c located at a point Q1 that is closer to the first end surface 12e than the middle portion 40.

The second protruding portion 41b is a portion in which the thickness in the width direction y with respect to the first lateral surface 12c is larger than that of the middle portion 40, and is a portion of the third base electrode layer 32c located at a point Q2 that is closer to the second end surface 12f than the middle portion 40.

At least one of the first and second protruding portions 41a and 41b has the largest thickness of the third base electrode layer 32c.

Further, the third base electrode layer 32c includes limit points 45, each of which, for example, is about 3 μm or more from a base electrode end portion 35, which is an end portion of the third base electrode layer 32c. In FIG. 9, a portion where the thickness in the width direction y of the third base electrode layer 32c with respect to the first lateral surface 12c is, for example, about 3 μm is indicated as h (=3 μm). The base electrode end portion 35 includes a first base electrode end portion 35a adjacent to the first end surface 12e and a second base electrode end portion 35b adjacent to the second end surface 12f of the third base electrode layer 32c. The first base electrode end portion 35a (corresponding to the first external electrode end portion) is an end portion of the third base electrode layer 32c adjacent to the first end surface 12e. The second base electrode end portion 35b (corresponding to the second external electrode end portion) is an end portion of the third base electrode layer 32c adjacent to the second end surface 12f. The limit points 45 include a first limit point 45a and a second limit point 45b.

The first limit point 45a is a portion of the third base electrode layer 32c located at a point P1 adjacent to the first end surface 12e. At the point P1, for example, the thickness of the first limit point 45a in the width direction y with respect to the first lateral surface 12c is about 3 un or more from the first base electrode end portion 35a (point R1).

The second limit point 45b is a portion of the third base electrode layer 32c located at the point P2 adjacent to the second end surface 12f. At the point P2, for example, the thickness of the second limit point 45b in the width direction y with respect to the first lateral surface 12c is about 3 μm or more from the second base electrode end portion 35b (point R2).

In the multilayer body 12, the third extension electrode portion 28b₁ is located between the first limit point 45a and the second limit point 45b. Specifically, in the multilayer body 12, extension end portions 29 (a first extension end portion 29a adjacent to the first end surface 12e and a second extension end portion 29b adjacent to the second end surface 12f) of the third extension electrode portion 28b₁ are located between the first limit point 45a and the second limit point 45b.

In addition, it can be considered that the third base electrode layer 32c includes a middle region 50c, a first end surface side region 50a, and a second end surface side region 50b. The middle region 50c is a region including the middle portion 40, and is a region between the first protruding portion 41a and the second protruding portion 41b. The first end surface side region 50a is a region closer to the first end surface 12e than the middle region 50c. The second end surface side region 50b is a region closer to the second end surface 12f than the middle region 50c. The first protruding portion 41a is located at the boundary between the middle region 50c and the first end surface side region 50a. The second protruding portion 41b is located at the boundary between the middle region 50c and the second end surface side region 50b. The first limit point 45a is located in the first end surface side region 50a. The second limit point 45b is located in the second end surface side region 50b. Each of the first protruding portion 41a and the second protruding portion 41b has a thickness larger than that of the middle portion 40, and has the largest thickness in the third base electrode layer 32c. Although the thickness of the third base electrode layer 32c decreases from the first protruding portion 41a toward the first base electrode end portion 35a, since the thickness of the first protruding portion 41a is large, it is possible to provide the first limit point 45a closer to the first end surface 12e than the first protruding portion 41a. In addition, although the thickness of the third base electrode layer 32c decreases from the second protruding portion 41b toward the second base electrode end portion 35b, since the thickness of the second protruding portion 41b is large, it is possible to provide the second limit point 45b closer to the second end surface 12f than the second protruding portion 41b.

As shown in FIG. 9, when defining that the distance from the first base electrode end portion 35a (point R1) to the first limit point 45a (point P1) and the distance from the second base electrode end portion 35b (point R2) to the second limit point 45b (point P2) are respectively f and the width of the third base electrode layer 32c in the length direction z is e (distance from point R1 to point R2), it is preferable that, for example, about 0.01≤f/e≤about 0.09.

When the distance a1 from the first base electrode end portion 35a (point R1) to the first protruding portion 41a (point Q1) and the distance a2 from the second base electrode end portion 35b (point R2) to the second protruding portion 41b (point Q2) are represented by a respectively, it is preferable that, for example, about 0.10≤a/e≤about 0.30.

When the thickness d1 of the first protruding portion 41a in the width direction y with respect to the first lateral surface 12c and the thickness d2 of the second protruding portion 41b in the width direction y with respect to the first lateral surface 12c are represented by d respectively, and the thickness of the middle portion 40 in the width direction y with respect to the first lateral surface 12c is represented by c, it is preferable that, for example, about 0.65≤c/d≤about 0.97.

In addition, the thickness c of the middle portion 40 is preferably, for example, about 8.0 μm≤c≤about 18.0 μm.

In addition, the thickness d of the first and second protruding portions 41a and 41b is preferably, for example, about 10.0 μm≤d≤about 21.0 μm.

In addition, the width e of the third base electrode layer 32c is preferably, for example, about 200 μm≤e≤about 600 pam. Further, for example, about 230 μm≤e≤about 390 μm is more preferable.

Next, the alloy layer 62 provided between the third base electrode layer 32c and the third extension electrode portion 28b₁, and the glass ratio will be described. As shown in FIG. 10, the third base electrode layer 32c and the third extension electrode portion 28b₁ are in contact with each other at a contact interface 60a of the first lateral surface 12c and are bonded to each other. At the contact interface 60a, for example, Ni in the third extension electrode portion 28b₁ and Cu in the third base electrode layer 32c are mutually diffused to form the alloy layer 62. The alloy layer 62 is formed to be denser than the third extension electrode portion 28b₁ and the third base electrode layer 32c itself, and improves the bonding strength between the third extension electrode portion 28b₁ and the third base electrode layer 32c.

The third base electrode layer 32c includes contact regions 60 and non-contact regions 61. The contact regions 60 include a contact interface 60a and an out-of-interface region 60b. The contact interface 60a is an interface where the third base electrode layer 32c is in contact with the third extension electrode portion 28b₁. The alloy layer 62 is provided at the contact interface 60a. The contact region 60 is a portion of the third base electrode layer 32c extending from the contact interface 60a to the outside in the width direction y. The out-of-interface region 60b is a region excluding the contact interface 60a in the contact region 60. That is, the out-of-interface region 60b is a region excluding the region where the alloy layer 62 is provided in the contact region 60. The non-contact regions 61 are portions of the third base electrode layer 32c other than the contact region 60, and are regions where the third base electrode layer 32c is not in contact with the third extension electrode portion 28b₁. The non-contact regions 61 include a first non-contact region 61a closer to the first end surface 12e than the contact region 60 and a second non-contact region 61b closer to the second end surface 12f than the contact region 60.

In FIG. 10, the contact region 60 is located between the first protruding portion 41a and the second protruding portion 41b. However, as described above, since the third extension electrode portion 28b₁ is required to be positioned so as to fit between the first limit point 45a and the second limit point 45b, the contact region 60 is required to be provided between the first limit point 45a and the second limit point 45b. In addition, it is preferable that the middle portion 40 is included in the contact region 60.

Here, an out-of-interface region glass ratio, which is a ratio of a glass component to components of the third base electrode layer 32c, in the out-of-interface region 60b, is defined as g1. In addition, a non-contact region glass ratio, which is a ratio of a glass component to components of the third base electrode layer 32c, in the non-contact region 61 is defined as g2. In this case, the relationship of out-of-interface region glass ratio g1>the non-contact region glass ratio g2 is satisfied. More specifically, when a first non-contact region glass ratio, which is a ratio of a glass component to components of the third base electrode layer 32c, in the first non-contact region 61a is defined as g2a, and a second non-contact region glass ratio, which is a ratio of a glass component to components of the third base electrode layer 32c, in the second non-contact region 61b is defined as g2b, the relationship of out-of-interface region glass ratio g1>the first non-contact region glass ratio g2a, the second non-contact region glass ratio g2b is satisfied. The out-of-interface region glass ratio g1 is preferably, for example, about 1.4 times or more and about 1.7 times or less than the non-contact region glass ratio g2 (the average of the first non-contact region glass ratio g2a and the second non-contact region glass ratio g2b).

Next, the fourth base electrode layer 32d includes the same or substantially the same configuration as the third base electrode layer 32c, but will be briefly described below. The fourth base electrode layer 32d includes a middle portion 40 having a thickness of, for example, about 3 μm or more with respect to the second lateral surface 12d, and protruding portions 41 including a first protruding portion 41a and a second protruding portion 41b. The fourth base electrode layer 32d includes a first limit point 45a at which the thickness of the fourth base electrode layer 32d with respect to the second lateral surface 12d is, for example, about 3 μm or more from the first base electrode end portion 35a, and a second limit point 45b at which the thickness of the fourth base electrode layer 32d with respect to the second lateral surface 12d is, for example, about 3 μm or more from the second base electrode end portion 35b. In the multilayer body 12, the fourth extension electrode portion 28b2 is located between the first limit point 45a and the second limit point 45b. Specifically, in the multilayer body 12, the first extension end portion 29a adjacent to the first end surface 12e and the second extension end portion 29b adjacent to the second end surface 12f of the fourth extension electrode portion 28b2 are located between the first limit point 45a and the second limit point 45b.

The distance f from the first and second base electrode end portions 35a and 35b (points R1 and R2) to the first and second limit points 45a and 45b (points P1 and P2) in the fourth base electrode layer 32d, the width e in the length direction z of the fourth base electrode layer 32d (distance from the point R1 to the point R2), the distance a from the first and second base electrode end portions 35a and 35b (points R1 and R2) to the first and second protruding portions 41a and 41b (points Q1 and Q2), the thickness d of the first and second protruding portions 41a and 41b in the width direction y with respect to the second lateral surface 12d, the thickness c of the middle portion 40 in the width direction y with respect to the second lateral surface 12d, and the out-of-interface region glass ratio g1 and the non-contact region glass ratio g2 in the fourth base electrode layer 32d are the same or substantially the same as those described above with respect to the third base electrode layer 32c.

The dimension in the length direction z of the three-terminal multilayer ceramic capacitor 10 including the multilayer body 12 and the first to fourth external electrodes 30a to 30d is defined as an L dimension, the dimension in the height direction x is defined as a T dimension, and the dimension in the width direction y is defined as a W dimension. The dimensions of the three-terminal multilayer ceramic capacitor 10 are not particularly limited, but, for example, the L dimension in the length direction z is about 1.05 mm or more and about 1.35 mm or less, the T dimension in the height direction x is about 0.45 mm or more and about 0.90 mm or less, and the W dimension in the width direction y is about 0.60 mm or more and about 0.95 mm or less. In addition, it is possible to measure the dimensions of the three-terminal multilayer ceramic capacitor 10 by a microscope.

Next, an example of a method of manufacturing a three-terminal multilayer ceramic capacitor according to an example embodiment of the present invention will be described.

First, a dielectric sheet for manufacturing a ceramic layer and an electrically conductive paste for manufacturing an internal electrode layer are prepared. The dielectric sheet and the electrically conductive paste for manufacturing the internal electrode layer includes a binder and a solvent. The binder and the solvent may be known.

Then, an electrically conductive paste for manufacturing the internal electrode layer is printed on the dielectric sheet in a predetermined pattern by, for example, gravure printing or screen printing. With such a configuration, the dielectric sheet on which the pattern of the first internal electrode layer is formed and the dielectric sheet on which the pattern of the second internal electrode layer is formed are prepared.

Subsequently, a predetermined number of dielectric sheets for manufacturing the outer layer on which the pattern of the internal electrode layer is not printed are laminated to form a portion defining and functioning as the second main surface-side outer layer portion on the second main surface. Then, the dielectric sheet on which the pattern of the first internal electrode layer is printed and the dielectric sheet on which the pattern of the second internal electrode layer is printed are sequentially laminated on the portion defining and functioning as the second main surface-side outer layer portion so as to have the configuration of an example embodiment of the present invention, such that the portion defining and functioning as the inner layer portion is formed. A predetermined number of dielectric sheets for manufacturing the outer layer on which the pattern of the internal electrode layer is not printed are laminated on the portion defining and functioning as the inner layer portion, such that the portion defining and functioning as the first main surface-side outer layer portion on the first main surface is formed. With such a configuration, a multilayer sheet is produced.

Next, a multilayer block is produced by pressing the laminated sheet in the lamination direction by, for example, isostatic pressing or the like.

Then, the multilayer chip is cut out by cutting the multilayer block into a predetermined size. At this time, corner portions and ridge portions of the multilayer chip may be rounded by barrel polishing or the like, for example.

Subsequently, a multilayer body is produced by firing the cut-out multilayer chip. The firing temperature is preferably, for example, about 900° C. or more and about 1400° C. or less depending on the materials of the ceramic layers and the internal electrode layers.

Next, the third base electrode layer 32c of the third external electrode 30c is formed on the first lateral surface 12c of the multilayer body 12 obtained by firing, and the fourth base electrode layer 32d of the fourth external electrode 30d is formed on the second lateral surface 12d of the multilayer body 12.

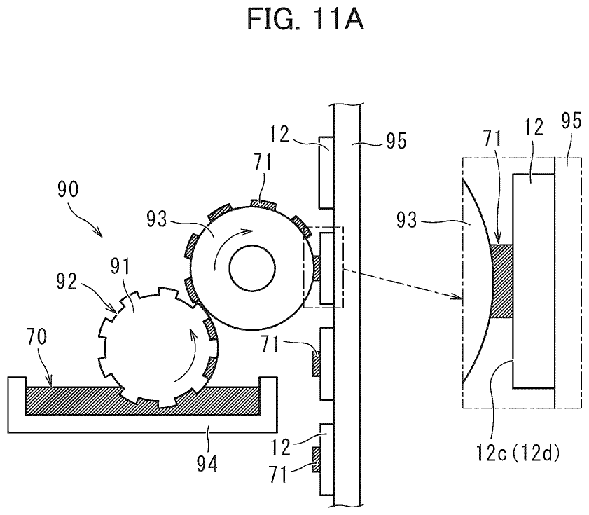

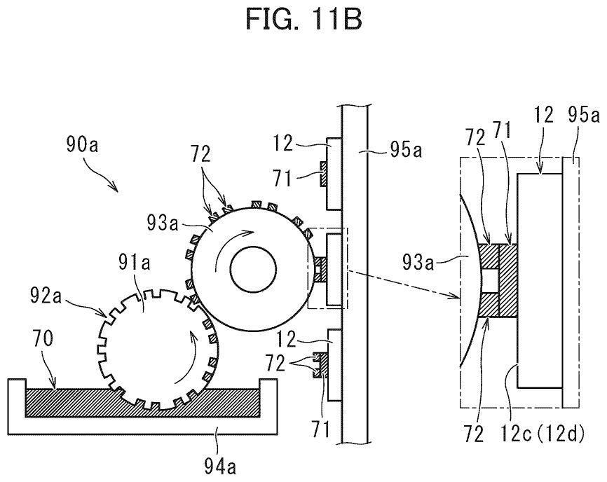

The third and fourth base electrode layers 32c and 32d each including the first protruding portion 41a and the second protruding portion 41b can be formed, for example, by applying the external electrode paste 70 twice using a roller transfer method. FIG. 11A is a process diagram showing a first application step of applying a first paste layer to the multilayer body, and FIG. 11B is a process diagram showing a second application step of applying a second paste layer to the multilayer body.

As shown in FIG. 11A, the first application step is performed by a first application mechanism 90. The first application mechanism 90 includes a first supply roller 91 including a plurality of first recessed portions 92, a first application roller 93, a first paste tank 94 in which the external electrode paste 70 is stored, and a first carrier tape 95 that conveys the multilayer body 12. A portion of the first supply roller 91 is immersed in the external electrode paste 70 in the first paste tank 94 while rotating, such that the external electrode paste 70 is sequentially adhered to the plurality of first recessed portions 92. Each of the first recessed portions 92 has a shape capable of forming the first paste layer 71 on the first lateral surface 12c or the second lateral surface 12d of the multilayer body 12. In the example of FIG. 11A, each of the first recessed portions 92 includes one recessed portion including a flat bottom surface, and the first paste layer 71 is formed as a continuous layer by the first recessed portion 92. The external electrode paste 70 in the first recessed portion 92 of the first supply roller 91 is transferred to the outer peripheral surface of the rotating first application roller 93 as a first paste layer 71. Then, the first paste layer 71 is flatly applied to the first lateral surface 12c or the second lateral surface 12d of each of the plurality of multilayer bodies 12 sequentially conveyed along the first carrier tape 95.

Next, as shown in FIG. 11B, the second application step is performed by a second application mechanism 90a. The second application mechanism 90a includes a second supply roller 91a including a plurality of second recessed portions 92a, a second application roller 93a, a second paste tank 94a in which the external electrode paste 70 is stored, and a second carrier tape 95a that conveys the multilayer body 12 to which the first paste layers 71 are applied. A portion of the second supply roller 91a is immersed in the external electrode paste 70 in the second paste tank 94a while rotating, such that the external electrode paste 70 sequentially adheres to the plurality of second recessed portions 92a. Each of the second recessed portions 92a has a shape capable of forming the second paste layer 72 of the second time on the first paste layer 71 of the multilayer body 12. In the example of FIG. 11B, each of the second recessed portions 92a is formed by dividing one recessed portion into two along the rotation direction, and each of the second paste layers 72 is formed as two divided layers along the rotation direction by the second recessed portion 92a. The external electrode paste 70 in the second recessed portion 92a of the second supply roller 91a is transferred to the outer peripheral surface of the rotating second application roller 93a as a second paste layer 72. Then, the second paste layer 72 is applied to the first paste layers 71 of the plurality of multilayer bodies 12 which are sequentially conveyed along the second carrier tape 95a. With such a configuration, the two divided second paste layers 72 are applied to both end portions of the first paste layer 71. The thickness of the paste layer is large in a portion where the first paste layer 71 and the second paste layer 72 are laminated, and the thickness of the paste layer is small in a portion of only the first paste layer 71 between the second paste layer 72 and the second paste layer 72. When the paste having such a shape is fired, the base electrode layer 32 including the first protruding portion 41a and the second protruding portion 41b for which both end portions are thicker than the middle portion is formed.

In addition, the external electrode paste 70 may be applied to the multilayer body 12 by being extruded from a slit having a desired shape.

The external electrode paste 70 is required to be a paste capable of forming the third and fourth base electrode layers 32c and 32d having the above-described shapes. Further, the external electrode paste 70 is preferably a paste that can reduce or prevent swelling of the middle portion compared to the end portion when the base electrode layer 32 is formed using the external electrode paste 70. For example, the external electrode paste 70 includes a resin, a metal filler, and a solvent. With such a configuration, it is possible to reduce or prevent swelling of the middle portion 40 of the third and fourth base electrode layers 32c and 32d, such that it is possible to reduce the thickness and size of the three-terminal multilayer ceramic capacitor 10 by reducing or preventing an increase in the size thereof, and the first and second protruding portions 41a and 41b can be easily formed.

The type of the resin is not particularly limited as long as the desired advantageous effects are provided. As the resin, various resins conventionally blended in the external electrode paste 70 can be used without particular limitation. Examples of preferred resins include cellulose resins, acrylic resins, or butyral resins. From the viewpoint of easily obtaining the external electrode paste 70 having a viscosity suitable for forming the external electrode, it is particularly preferable that the resin includes a cellulose-based resin, for example. It is also preferable that the resin includes, for example, a copolymer resin including a block derived from a cellulose-based resin. The copolymer resin may be a block copolymer or a graft copolymer, for example.

The cellulose-based resin is, for example, at least one of ethyl cellulose, methyl cellulose, hydroxypropyl cellulose, trityl cellulose, acetyl cellulose, carboxymethyl cellulose, or nitrocellulose.

The acrylic resin is, for example, a homopolymer or copolymer of one or more monomers including isobutyl methacrylate, methyl methacrylate, hydroxyethyl methacrylate, hydroxypropyl methacrylate, n-butyl methacrylate, or 2-ethylhexyl methacrylate.

The metal filler includes a metal of the external electrode. The type of metal of the metal filler is appropriately selected according to the type of metal of the external electrode. For example, copper (Cu), silver (Ag), nickel (Ni), or an alloy including these metals is preferable used as the metal in view of excellent conductivity and ease of availability of a metal filler having a desired particle size. It is preferable that the alloy including these metals includes one or more of copper (Cu), silver (Ag), or nickel (Ni). It is also preferable, for example, that the alloy including these metals includes tin (Sn).

The solvent dissolves the resin, disperses the metal filler, and is added as a component that imparts fluidity to the external electrode paste 70.

The solvent includes one or more first solvents and one or more second solvents. The ratio of the mass of the first solvent to the mass of the solvent and the ratio of the mass of the second solvent to the mass of the solvent are each, for example, about 40% by mass or more. The lowest boiling point T^{Hl} among the boiling points of the one or more second solvents under atmospheric pressure is higher than the highest boiling point T^{Lh} among the boiling points of the one or more first solvents under atmospheric pressure by, for example, about 10° C. or more. Among the boiling points of one or more second solvents under atmospheric pressure, the highest boiling point T^{Hh} is, for example, equal to or lower than T^{H1}+about 10° C. Among the boiling points of one or more first solvents under atmospheric pressure, the lowest boiling point T^{L1} is equal to or higher than T^{Lh}−about 10° C. The solvent may include a sub-solvent in addition to the first solvent and the second solvent. The boiling point of the sub-solvent under atmospheric pressure is less than (T^{L1}−10) ° C., greater than (T^{Lh}+10°) C and less than (T^{H1}−10°) C, or greater than (T^{Hh}+10° C.)

Specific examples of suitable solvents include texanol, propylene glycol monophenyl ether, butyl carbitol, terpene solvents, diethylene glycol, carbitol acetate, butyl carbitol acetate, benzyl alcohol, methyl propylene diglycol, diphenyl ether, ethylene glycol, or the like.

In addition, for example, the external electrode paste 70 includes a resin including an ethylcellulose-based resin and an acrylic resin, at least a portion of which is copolymerized, a Cu filler, and a solvent. The interfacial tension generated between the resin and the solvent is preferably, for example, about 15 mN/m or more. The resin and the solvent are as described above.

Next, an example of a manufacturing method according to an example embodiment of the present invention in a case in which the base electrode layer 32 is a fired layer or an electrically conductive resin layer will be described.

When a fired layer is formed as the third base electrode layer 32c and the fourth base electrode layer 32d, an electrically conductive paste (external electrode paste 70) including a glass component and a metal component is applied, and then firing is performed to form a base electrode layer. The electrically conductive paste can be applied by, for example, the first application step and the second application step described above. Thereafter, firing is performed to form a base electrode layer. The temperature of the firing treatment at this time is preferably, for example, about 700° C. or more and about 900° C. or less. In addition, in the Experimental Examples described later, the base electrode layer 32 includes a fired layer.

In addition, in the case of the roller transfer method, when the base electrode layer 32 is formed not only on the first lateral surface 12c and the second lateral surface 12d, but also on a portion of the first main surface 12a and a portion of the second main surface 12b, it is possible to form the base electrode layer 32 on a portion of the first main surface 12a and a portion of the second main surface 12b by increasing the pressing pressure during roller transfer of the external electrode paste 70. In addition, in the case of the method of applying the external electrode paste 70 by extruding the paste from the slits, it is possible to form the base electrode layer 32 not only on the first lateral surface 12c and the second lateral surface 12d, but also on a portion of the first main surface 12a and a portion of the second main surface 12b by increasing the extruding amount of the external electrode paste 70.

In addition, when the third base electrode layer 32c and the fourth base electrode layer 32d are formed of an electrically conductive resin layer, it is possible to form the electrically conductive resin layer by the following method, for example. In addition, the electrically conductive resin layer may be formed on the surface of the fired layer, or the electrically conductive resin layer may be formed directly on the multilayer body 12 as a single body without forming the fired layer.

As an example of a method of forming the electrically conductive resin layer, an electrically conductive resin paste (external electrode paste 70) including a thermosetting resin and a metal component is applied onto the fired layer or the multilayer body 12. The electrically conductive resin paste can be applied by, for example, the first application step and the second application step described above. Thereafter, heat treatment is performed at a temperature ranging from, for example, about 250° C. to about 550° C. to thermally cure the resin to form the electrically conductive resin layer. At this time, the atmosphere during the heat treatment is preferably, for example, an N₂ atmosphere. In addition, in order to prevent scattering of the resin and oxidation of various metal components, it is preferable to reduce the oxygen concentration to, for example, about 100 ppm or less.

In addition, as a method of applying the electrically conductive resin paste, for example, it is possible to use a method of applying the electrically conductive resin paste by extruding the electrically conductive resin paste through a slit or a roller transfer method in the same manner as the method of forming the base electrode layer 32 with the fired layer.

Next, the first base electrode layer 32a of the first external electrode 30a and the second base electrode layer 32b of the second external electrode 30b are formed on the first end surface 12e and the second end surface 12f, respectively, in the multilayer body obtained by firing. Similarly to the third base electrode layer 32c and the fourth base electrode layer 32d, in the case of forming a fired layer as the first base electrode layer 32a and the second base electrode layer 32b, an electrically conductive paste including a glass component and a metal component is applied and then firing is performed to form a base electrode layer. The temperature of the firing treatment at this time is preferably, for example, about 700° C. or more and about 900° C. or less. As a method of applying the electrically conductive paste to both end surfaces of the multilayer body, for example, a method such as a dipping method or a screen printing method is used. In the Experimental Examples described later, the first base electrode layer 32a and the second base electrode layer 32b are formed by dipping so as to extend not only to the first end surface 12e and the second end surface 12f but also to a portion of the first main surface 12a, a portion of the second main surface 12b, a portion of the first lateral surface 12c, and a portion of the second lateral surface 12d.

In addition, in the firing process, the third base electrode layer 32c, the fourth base electrode layer 32d, the first base electrode layer 32a, and the second base electrode layer 32b may be simultaneously fired, or may be fired on both lateral surfaces 12c and 12d and on both end surfaces 12e and 12f separately.

In addition, when the base electrode layer includes a fired layer, the fired layer may include a dielectric component. In this case, a dielectric component may be included instead of the glass component, or both of them may be included.

The dielectric component is preferably, for example, a dielectric material of the same type as the multilayer body. In addition, when a dielectric component is included in the fired layer, it is preferable that the electrically conductive paste is applied to the multilayer chip before firing, and the multilayer chip before firing and the electrically conductive paste applied to the multilayer chip before firing are simultaneously fired (fired) to form a multilayer body in which the fired layer is formed. The temperature of the firing treatment at this time (firing temperature) is preferably, for example, about 900° C. or more and about 1400° C. or less.

Next, the plated layer 34 is formed. The plated layer 34 may be formed on the surface of the base electrode layer 32 or may be formed directly on the multilayer body 12. In addition, in the Experimental Examples described later, the plated layer 34 is formed on the surface of the base electrode layer 32. More specifically, for example, a Ni plated layer is formed as a lower plated layer on the base electrode layer 32, and a Sn plated layer is formed as an upper plated layer. It is possible to sequentially form the Ni plated layer and the Sn plated layer by barrel plating, for example. When plating is performed, either electrolytic plating or electroless plating may be used. However, electroless plating requires pretreatment with a catalyst or the like in order to improve the plating deposition rate, and has a disadvantage that the process becomes complicated. Therefore, in general, it is preferable to employ electrolytic plating.

As described above, the three-terminal multilayer ceramic capacitor 10 according to the present example embodiment is manufactured.

Hereinafter, the advantageous effects of the three-terminal multilayer ceramic capacitor 10 will be described.

According to the above configuration, the third and fourth base electrode layers 32c and 32d including the first and second protruding portions 41a and 41b each have a large thickness range of, for example, about 3 μm or more. Therefore, since the tolerance for misalignment of the second internal electrode layer 16b with respect to the third and fourth base electrode layers 32c and 32d is large, it is possible to improve the moisture resistance reliability. This will be specifically described below.

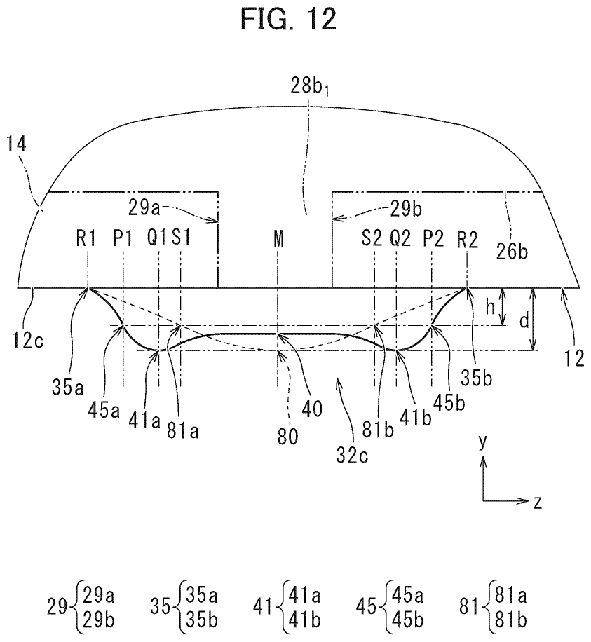

According to the above configuration, the third and fourth base electrode layers 32c and 32d each include the first protruding portion 41a adjacent to the first end surface 12e and the second protruding portion 41b adjacent to the second end surface 12f. The first protruding portion 41a and the second protruding portion 41b are thicker than the middle portion 40 having a thickness of, for example, about 3 μm or more. The middle portion is interposed between the first protruding portion 41a and the second protruding portion 41b. Therefore, the third and fourth base electrode layers 32c and 32d including the first and second protruding portions 41a and 41b are each larger in thickness on the portions respectively adjacent to the first and second end surfaces 12e and 12f, when compared to the third and fourth base electrode layers 32c and 32d having, for example, a shape in which the thickness of the middle portion 40 not including the first and second protruding portions 41a and 41b is the largest and the thickness becomes smaller as it approaches the first and second end surfaces 12e and 12f. This point will be further described with reference to FIG. 12.

FIG. 12 is a schematic view for explaining a difference in configuration between the three-terminal multilayer ceramic capacitor according to the present example embodiment of the present invention and an existing three-terminal multilayer ceramic capacitor. In FIG. 12, the third base electrode layer 32c according to the present example embodiment is indicated by a solid line, and the third base electrode layer (hereinafter, referred to as an existing base electrode layer) of an existing three-terminal multilayer ceramic capacitor is indicated by a broken line. The third base electrode layer 32c according to the present example embodiment includes the middle portion 40 of the point M and the first and second protruding portions 41a and 41b of the point Q1 and the point Q2, and the thickness of the first and second protruding portions 41a and 41b is d. The thickness d of the first and second protruding portions 41a and 41b is the largest in the third base electrode layer 32c. The third base electrode layer 32c according to the present example embodiment includes a first limit point 45a at a point P1 between the first protruding portion 41a and the first base electrode end portion 35a of the point R1, and includes a second limit point 45b at a point P2 between the second protruding portion 41b and the second base electrode end portion 35b of the point R2. As described above, the thickness h of the first and second limit points 45a and 45b is, for example, about 3 μm.

On the other hand, the existing base electrode layer includes one apex portion 80 at the point M. The thickness of the apex portion 80 is the same d as that of the first and second protruding portions 41a and 41b. The existing base electrode layer also includes first and second base electrode end portions at points R1 and R2. According to FIG. 12, in the existing base electrode layer, the point Si and the point S2 of the reference limit point 81 (the first reference limit point 81a and the second reference limit point 81b) are where the thickness of the existing base electrode layer is, for example, about 3 μm or more from the first and second base electrode end portions (the point R1 and the point R2).

While the range from the first limit point 45a to the second limit point 45b of the third base electrode layer 32c according to the present example embodiment is from the point P1 to the point P2, the range from the first reference limit point 81a to the second reference limit point 81b of the existing base electrode layer is from the point Si to the point S2. The relationship of the range from the point P1 to the point P2>the range from the point Si to the point S2 is satisfied. This is because, since the third base electrode layer 32c according to the present example embodiment includes the first and second protruding portions 41a and 41b, the slope in which the thickness increases from the first and second base electrode end portions 35a and 35b is larger than that of the existing base electrode layer. The same applies to the fourth base electrode layer 32d.

As described above, in the third and fourth base electrode layers 32c and 32d according to the present example embodiment, the first limit point 45a having a thickness of, for example, about 3 μm or more from the first base electrode end portion 35a is located adjacent to the first end surface 12e, and the second limit point 45b having a thickness of, for example, about 3 μm or more from the second base electrode end portion 35b is located adjacent to the second end surface 12f. Since the range from the first limit point 45a to the second limit point 45b having a thickness of, for example, about 3 μm or more is large as described above, it is possible to easily position the first and second extension end portions 29a and 29b within the range between the first limit point 45a and the second limit point 45b. That is, it is possible to increase the tolerance for misalignment of the second internal electrode layer 16b with respect to the third and fourth base electrode layers 32c and 32d. Therefore, it is possible to reduce or prevent misalignment of, for example, at least a portion of the third and fourth extension electrode portions 28b₁ and 28b2 being provided outside the third and fourth base electrode layers 32c and 32d, and as a result, it is possible to reduce or prevent the infiltration of moisture into the multilayer body 12 via the third and fourth extension electrode portions 28b₁ and 28b2, and to improve moisture resistance reliability.

The distance f respectively from the first and second base electrode end portions 35a and 35b to the first and second limit points 45a and 45b is preferably as small as, for example, about 0.01 or more and about 0.09 or less with respect to the width e of each of the third and fourth base electrode layers 32c and 32d. This is probably because each of the third and fourth base electrode layers 32c and 32d bulges with large slopes from the first and second base electrode end portions 35a and 35b to satisfy a thickness of, for example, about 3 un or more, thus providing the first and second protruding portions 41a and 41b. Therefore, since the range from the first limit point 45a to the second limit point 45b having a thickness of, for example, about 3 μm or more is large, the tolerance for misalignment of the second internal electrode layer 16b with respect to the third and fourth base electrode layers 32c and 32d is large. Therefore, it is possible to further reduce or prevent misalignment of the third and fourth extension electrode portions 28b₁ and 28b2 with respect to the third and fourth base electrode layers 32c and 32d, and it is possible to further improve the moisture resistance reliability.

The distance a respectively from the first and second base electrode end portions 35a and 35b to the first and second protruding portions 41a and 41b is preferably, for example, as small as about 0.10 or more and about 0.30 or less with respect to the width e of each of the third and fourth base electrode layers 32c and 32d. With such a configuration, it is possible to make the distance f respectively from the first and second base electrode end portions 35a and 35b to the first and second limit points 45a and 45b having a thickness of, for example, about 3 μm or more smaller than the width e of each of the third and fourth base electrode layers 32c and 32d. Therefore, since the range from the first limit point 45a to the second limit point 45b is large, it is possible to further reduce or prevent misalignment of the third and fourth extension electrode portions 28b₁ and 28b2 with respect to the third and fourth base electrode layers 32c and 32d, and it is possible to further improve the moisture resistance reliability.

It is preferable that c/d is in the above range. Therefore, it is possible for the third and fourth base electrode layers 32c and 32d to include the first protruding portion 41a and the second protruding portion 41b at positions adjacent to the first and second end surfaces 12e and 12f, respectively. With such a configuration, it is possible to increase the range from the first limit point 45a to the second limit point 45b having a thickness of, for example, about 3 μm or more. Therefore, it is possible to further reduce or prevent misalignment of the third and fourth extension electrode portions 28b₁ and 28b2 with respect to the third and fourth base electrode layers 32c and 32d, and it is possible to further improve the moisture resistance reliability.

The thickness c of the middle portion 40 is preferably in the above range. Therefore, it is possible to reduce or prevent the thickness c from becoming too thick while setting the thickness c to, for example, about 3 un or more for ensuring the moisture resistance reliability. With such a configuration, it is possible to reduce the thickness and size of the three-terminal multilayer ceramic capacitor 10 by reducing or preventing an increase in size thereof while ensuring moisture resistance reliability.

The thickness d of each of the first and second protruding portions 41a and 41b is preferably in the above range. It is possible to increase the range from the first limit point 45a to the second limit point 45b while setting the thickness d to, for example, about 3 μm or more to ensure moisture resistance reliability and reduce or prevent the thickness d from becoming too thick. With such a configuration, it is possible to reduce the thickness and size of the three-terminal multilayer ceramic capacitor 10 by reducing or preventing an increase in size thereof while ensuring moisture resistance reliability.

At the contact interface 60a between the third and fourth base electrode layers 32c and 32d, and the third and fourth extension electrode portions 28b₁ and 28b2, the metal components of the third and fourth base electrode layers 32c and 32d react with the metal components of the third and fourth extension electrode portions 28b₁ and 28b2 during firing to form respective alloy layers 62. By forming the respective alloy layers 62, it is possible to improve the bonding strength between the third and fourth base electrode layers 32c and 32d and the third and fourth extension electrode portions 28b₁ and 28b2. At this time, the glass components of the third and fourth base electrode layers 32c and 32d are densely gathered in the out-of-interface region 60b, which is a portion spaced away from the contact interface 60a in the width direction y in the third and fourth base electrode layers 32c and 32d, thus forming dense glass layers. Therefore, the out-of-interface region glass ratio g1 is higher than the non-contact region glass ratio g2. Since the out-of-interface region glass ratio g1 is relatively large, sintering tends to easily proceed at the time of firing due to the presence of glass in the out-of-interface region 60b. Therefore, it is possible to reduce or prevent an increase in the size of the three-terminal multilayer ceramic capacitor 10 by reducing or preventing the swelling in the contact region 60, and it is possible to easily form the first and second protruding portions 41a and 41b by reducing or preventing the swelling in the contact region 60.

In the contact region 60 including the middle portion 40, the third and fourth extension electrode portions 28b₁ and 28b₂ are in contact with the third and fourth base electrode layers 32c and 32d, respectively. In the contact region 60, the glass components of the third and fourth base electrode layers 32c and 32d are densely gathered in the out-of-interface region 60b separated from the contact interface 60a in the width direction y in the third and fourth base electrode layers 32c and 32d, thus forming a dense glass layer. When the glass component is present, sintering tends to proceed easily at the time of firing, and thus the contact region 60 including the middle portion 40 is likely to have a shape recessed more than the first and second protruding portions 41a and 41b in a cross-sectional view along the first and second main surfaces 12a and 12b. On the other hand, in the first and second non-contact regions 61a and 61b, since the non-contact region glass ratio g2 is low, it is difficult to form a recessed shape, and it is possible to ensure the thickness of the first and second protruding portions 41a and 41b. As described above, in the contact region 60 including the middle portion 40, it is possible to reduce or prevent the thicknesses of the third and fourth base electrode layers 32c and 32d, and in the first and second non-contact regions 61a and 61b, it is possible to ensure thicknesses in order to ensure moisture resistance reliability. Therefore, it is possible to reduce or prevent misalignment of the third and fourth extension electrode portions 28b₁ and 28b2 with respect to the third and fourth base electrode layers 32c and 32d and to form the third and fourth base electrode layers 32c and 32d having shapes capable of improving moisture resistance reliability.

Next, as a sample of an experiment, three-terminal multilayer ceramic capacitors were manufactured by the manufacturing method described above.

Three-terminal multilayer ceramic capacitors according to Examples 1 to 12 were produced in accordance with the above-described method for manufacturing a multilayer ceramic capacitor.

Here, for the dimensions of each portion of the third and fourth base electrode layers, the thickness of the first protruding portion in the width direction y is defined as d1, the thickness of the second protruding portion in the width direction y is defined as d2, the thickness of the middle portion in the width direction y is defined as c, the width of the third (fourth) base electrode layer in the length direction z is defined as e, the distance from the first protruding portion to the first base electrode end portion is defined as a1, the distance from the second protruding portion to the second base electrode end portion is defined as a2, and the distance from the base electrode end portion having the smaller distance among the distance a1 and the distance a2 to the first (second) limit point is defined as f, and the distance from the protruding portion having the smaller distance among the distance a1 and the distance a2 to the first (second) limit point is defined as i.

Table 1 shows d1 ((μm), c/d1, d2 (μm), c/d2, |d1−d2|(μm), c(μm), and d1(d2)−c (μm), obtained by subtracting c from the larger of d1 and d2, for Examples 1 to 12.

TABLE 1

| | | | | | | | | Moisture |
|---|---|---|---|---|---|---|---|---|
| | | | | | | | | Resistance |
| Sample | | | | | \|d1 − d2\| | | (d1(d2)) − c | Reliability |
| Number | d1(um) | c/d1 | d2(um) | c/d2 | (um) | c(um) | (um) | Test |
| Example 1 | 12.3 | 0.77 | 11.6 | 0.82 | 0.7 | 9.5 | 2.8 | ◯ |
| Example 2 | 10.9 | 0.83 | 11.6 | 0.78 | 0.7 | 9.0 | 2.6 | ◯ |
| Example 3 | 12.2 | 0.75 | 11.9 | 0.77 | 0.3 | 9.2 | 3.0 | ◯ |
| Example 4 | 14.1 | 0.70 | 13.4 | 0.73 | 0.7 | 9.8 | 4.3 | ◯ |
| Example 5 | 15.4 | 0.67 | 14.4 | 0.72 | 1.0 | 10.3 | 5.1 | ◯ |
| Example 6 | 14.4 | 0.76 | 15.5 | 0.71 | 1.1 | 11.0 | 4.5 | ◯ |
| Example 7 | 16.5 | 0.93 | 17.5 | 0.88 | 1.0 | 15.4 | 2.1 | ◯ |
| Example 8 | 17.5 | 0.88 | 17.4 | 0.89 | 0.1 | 15.4 | 2.1 | ◯ |
| Example 9 | 17.8 | 0.84 | 17.5 | 0.86 | 0.3 | 15.0 | 2.8 | ◯ |
| Example 10 | 20.0 | 0.89 | 18.7 | 0.95 | 1.3 | 17.7 | 2.3 | ◯ |
| Example 11 | 18.4 | 0.80 | 18.3 | 0.81 | 0.1 | 14.8 | 3.6 | ◯ |
| Example 12 | 18.1 | 0.81 | 18.0 | 0.82 | 0.1 | 14.7 | 3.4 | ◯ |

Table 2 shows e (μm), a1 (μm), a1/e, a2 (μm), a2/e, f(μm), f/e, and i (μm) for Examples 1 to 12.

TABLE 2

| Sample | | | | | | | | |
|---|---|---|---|---|---|---|---|---|
| Number | e(um) | a1(um) | a1/e | a2(um) | a2/e | f(um) | f/e | I(um) |
| Example 1 | 230.3 | 50.8 | 0.22 | 49.2 | 0.21 | 11.7 | 0.05 | 37.5 |
| Example 2 | 239.1 | 53.4 | 0.22 | 50.7 | 0.21 | 18.4 | 0.08 | 32.3 |
| Example 3 | 248.3 | 58.8 | 0.24 | 61.9 | 0.25 | 11.9 | 0.05 | 46.9 |
| Example 4 | 272.2 | 55.3 | 0.20 | 59.3 | 0.22 | 11.5 | 0.04 | 43.8 |
| Example 5 | 277.8 | 64.1 | 0.23 | 65.4 | 0.24 | 11.0 | 0.04 | 53.1 |
| Example 6 | 280.9 | 55.8 | 0.20 | 54.6 | 0.19 | 10.7 | 0.04 | 43.9 |
| Example 7 | 339.8 | 67.7 | 0.20 | 69.5 | 0.20 | 11.7 | 0.03 | 56.0 |
| Example 8 | 349.4 | 80.3 | 0.23 | 66.6 | 0.19 | 11.5 | 0.03 | 55.1 |
| Example 9 | 354.4 | 74.2 | 0.21 | 87.6 | 0.25 | 12.1 | 0.03 | 62.1 |
| Example | 384.7 | 70.9 | 0.18 | 86.6 | 0.23 | 8.4 | 0.02 | 62.5 |
| 10 | | | | | | | | |
| Example | 385.5 | 86.9 | 0.23 | 76.2 | 0.20 | 11.2 | 0.03 | 65.0 |
| 11 | | | | | | | | |
| Example | 367.1 | 61.6 | 0.17 | 80.5 | 0.22 | 12.3 | 0.03 | 49.3 |
| 12 | | | | | | | | |

The configuration of the three-terminal multilayer ceramic capacitor other than the dimensions of the third and fourth base electrode layers shown in Tables 1 and 2 is as follows, and is common to Examples 1 to 12.
Configuration of Three-Terminal Multilayer Ceramic Capacitor: Three Terminals (see FIG. 1)
Dimensions L×W×T (including design value) of Three-Terminal Multilayer Ceramic Capacitor: about 1.23 mm×about 0.93 mm×about 0.48 mm
Material of Ceramic Layers: BaTiO₃
Capacitance: about 22 μF
Rated Voltage: about 4 V
First Internal Electrode Layers
Material: Ni
Shape: see FIGS. 4 and 6
Number of Layers: 220 layers
Thickness of the First Internal Electrode Layers: about 0.42 μm
Second Internal Electrode Layers
Material: Ni
Shape: see FIGS. 5 and 7
Number of Layers: 220 layers
Thickness of the Second Internal Electrode Layers: about 0.42 μm
Configuration of External Electrode
First External Electrode and Second External Electrode
   Base Electrode Layer: Fired layer including electrically conductive metal (Cu) and glass component

Thickness of middle portion of end surface: about 16 μm
Plated Layer: Two-layer configuration of Ni plated layer and Sn plated layer
Thickness of Ni plated layer: about 5 μm
Thickness of Sn plated layer: about 5 μm
Third External Electrode and Fourth External Electrode
Base Electrode Layer: Fired layer including electrically conductive metal (Cu) and glass component
Plated Layer: Two-layer configuration of Ni plated layer and Sn plated layer
Thickness of Ni plated layer: about 4 μm
Thickness of Sn plated layer: about 5 μm

Moisture resistance reliability tests were performed on Examples 1 to 12.

Moisture resistance reliability tests were performed on the samples of Examples 1 to 12 based on the PCBT test method. More specifically, first, each sample was mounted on a mounting board using solder. Subsequently, the insulation resistance value IR of each sample was measured (the insulation resistance value after one hour from the start of the moisture resistance reliability test time). Next, the mounting board was placed in a high-temperature and high-humidity bath, and in an environment of about 125° C. and a relative humidity of about 95% RH, a DC current of about 4 V was applied between the first external electrode and the second external electrode of each sample and between the third external electrode and the fourth external electrode of each sample, and maintained for about 72 hours (humidity resistance reliability test time). After the moisture resistance reliability test time, the insulation resistance value IR of each sample was measured (the insulation resistance value after the moisture resistance reliability test time). For each sample, when the log IR after the moisture resistance reliability test time was lower than the log IR before the moisture resistance reliability test time by a power of about 0.5 or more, it was determined that the sample was deteriorated by IR. A sample having no IR degradation was determined to be good (indicated by circle symbol “O”), and a sample having IR degradation was determined to be poor (indicated by cross symbol “x”).

The results of the moisture resistance reliability test are shown in Table 1.

In addition, the glass ratios of Examples 7 to 9 were measured.

The glass ratio in the third and fourth base electrode layers can be measured by taking an electron micrograph of the LW plane including the third and fourth base electrode layers, and analyzing the region by elemental analysis using EDX (X-ray fluorescence analyzer). In the elemental analysis, the measurement is required to be performed focusing on an element included only in the glass among the components of the third and fourth base electrode layers.

Table 3 shows the out-of-interface region glass ratio g1, the first non-contact region glass ratio g2a, the second non-contact region glass ratio g2b, the non-contact region glass ratio g2 (average of g2a and g2b), g1/g2a, g1/g2b, and g1/g2.

TABLE 3

| Sample | | | | | | | |
|---|---|---|---|---|---|---|---|
| Number | g1 | g2a | g2b | g2 | g1/g2a | g1/g2b | g1/g2 |
| Example 7 | 18.8 | 15.7 | 9.4 | 12.5 | 1.2 | 2.0 | 1.5 |
| Example 8 | 15.8 | 8.2 | 10.3 | 9.2 | 1.9 | 1.5 | 1.7 |
| Example 9 | 22.0 | 15.9 | 15.3 | 15.6 | 1.4 | 1.4 | 1.4 |

In Examples 1 to 12 shown in Tables 1 to 3, the moisture resistance reliability tests were evaluated as good (indicated by circle symbol “∘”), and the moisture resistance reliability was ensured. Referring to Table 2, it was discovered that about 0.01≤f/e≤about 0.09 was preferable with reference to the minimum value and the maximum value of f/e. More preferably, about 0.02≤f/e≤about 0.08. Referring to Table 2, it was discovered that about 0.10≤a/e≤about 0.30 was preferable with reference to the minimum value and the maximum value of a1/e and a2/e. It is more preferable that about 0.17≤a/e≤about 0.25. Referring to Table 1, it was discovered that it is preferable that about 0.65≤c/d≤about 0.97 with reference to the minimum value and the maximum value of c/d1 and c/d2. It is more preferable that about 0.67≤c/d≤about 0.95. Referring to the minimum value and the maximum value of c from Table 1, it was discovered that about 8.0 μm≤vc≤about 18.0 μm was preferable. It is more preferable that about 9.0 μm≤c≤about 17.7 μm. Referring to Table 1, it was discovered that about 10.0 μm≤d≤about 21.0 μm was preferable with reference to the minimum value and the maximum value of d1 and d2. It is more preferable that about 10.9 μm≤d≤about 20.0 μm. With reference to the minimum value and the maximum value of e from Table 2, it was discovered that about 200 μm≤e≤about 600 μm was preferable. It is more preferable that about 230 μm≤e≤about 390 μm.

From Table 3, it was discovered that the relationship of the out-of-interface region glass ratio g1>the non-contact region glass ratio g2 was preferable. It is more preferable that about 1.4≤g1/g2≤about 1.7.

As described above, although example embodiments of the present invention are disclosed in the above description, the present invention is not limited thereto. That is, it is possible to make various modifications to the above-described example embodiment without departing from the gist and the scope of the object of the present invention with respect to the configuration, the shape, the material, the quantity, the position, the arrangement, and the like, and these modifications are included in the present invention.
(1) In the above-described example embodiment, for example, each of the third and fourth base electrode layers 32c and 32d includes the first and second protruding portions 41a and 41b, and includes the first limit point 45a adjacent to the first end surface 12e that is about 3 μm or more from the first base electrode end portion 35a and the second limit point 45b adjacent to the second end surface 12f that is about 3 μm or more from the second base electrode end portion 35b. The third and fourth extension electrode portions 28b₁ and 28b2 are provided so as to be fit between the first limit point 45a and the second limit point 45b.

Unlike this, the third and fourth extension electrode portions 28b₁ and 28b2 may be provided so as to be fit between the first outer limit point and the second outer limit point at which the thickness of the third and fourth external electrodes 30c and 30d as a whole is about 3 μm or more, for example.

Specifically, each of the third and fourth external electrodes 30c and 30d includes an outer middle portion, a first outer protruding portion 42a, and a second outer protruding portion 42b in a state including the third and fourth plated layers 34c and 34d, in addition to the third and fourth base electrode layers 32c and 32d. The outer middle portion, the first outer protruding portion 42a, and the second outer protruding portion 42b correspond to the middle portion 40, the first protruding portion 41a, and the second protruding portion 41b of the third and fourth base electrode layers 32c and 32d in the above example embodiment.

That is, for example, the outer middle portion is a portion of each of the third and fourth external electrodes 30c and 30d located at the point M that is the middle in the length direction z of the third and fourth external electrodes 30c and 30d, and the thickness in the width direction y with respect to the first and second lateral surfaces 12c and 12d is about 3 μm or more.

The first outer protruding portion 42a is a portion in which the thickness in the width direction y with respect to each of the first and second lateral surfaces 12c and 12d is larger than the outer middle portion, and is a portion of each of the third and fourth external electrodes 30c and 30d located at a point Q1 which is closer to the first end surface 12e than the outer middle portion.

The second outer protruding portion 42b is a portion in which the thickness in the width direction y with respect to each of the first and second lateral surfaces 12c and 12d is larger than the outer middle portion, and is a portion of each of the third and fourth external electrodes 30c and 30d located at a point Q2 that is closer to the second end surface 12f than the outer middle portion.

In addition, each of the third and fourth external electrodes 30c and 30d also includes a first outer limit point and a second outer limit point. The first and second outer limit points are limit points on the third and fourth plated layers 34c and 34d, and correspond to the first and second limit points 45a and 45b of the third and fourth base electrode layers 32c and 32d in the above example embodiment.

The first outer limit point is a portion of each of the third and fourth external electrodes 30c and 30d located at the point P1 adjacent to the first end surface 12e. At the point P1, the thickness of the first outer limit point in the width direction y with respect to the first and second lateral surfaces 12c and 12d is, for example, about 3 μm or more from the first external electrode end portion adjacent to the first end surface 12e. The first external electrode end portion is an end portion of each of the third and fourth external electrodes 30c and 30d adjacent to the first end surface 12e.

The second outer limit point is a portion of each of the third and fourth external electrodes 30c and 30d located at the point P2 adjacent to the second end surface 12f. At the point P2, the thickness of the second outer limit point in the width direction y with respect to the first and second lateral surfaces 12c and 12d is, for example, about 3 μm or more from the second external electrode end portion adjacent to the second end surface 12f. The second external electrode end portion is an end portion of each of the third and fourth external electrodes 30c and 30d adjacent to the second end surface 12f.

The third and fourth extension electrode portions 28b₁ and 28b2 are located between the first outer limit point and the second outer limit point. That is, the first extension end portion 29a and the second extension end portion 29b of the third and fourth extension electrode portions 28b₁ and 28b2 are located between the first outer limit point and the second outer limit point.

In addition, the thickness, distance, glass ratio, and the like of each portion of the third and fourth base electrode layers 32c and 32d in the above example embodiment correspond to the thickness, distance, glass ratio, and the like of each portion of the third and fourth external electrodes 30c and 30d. Specifically, in the third and fourth base electrode layers 32c and 32d, the distance f from the first and second base electrode end portions 35a and 35b to the first and second limit points 45a and 45b, the width e in the length direction z of the third and fourth base electrode layers 32c and 32d, the distance a from the first and second base electrode end portions 35a and 35b to the first and second protruding portions 41a and 41b, the thickness d of the first and second protruding portions 41a and 41b in the width direction y with respect to the first and second lateral surfaces 12c and 12d, the thickness c of the middle portion 40 in the width direction y with respect to the first and second lateral surfaces 12c and 12d, the out-of-interface region glass ratio g1, the non-contact region glass ratio g2, and the like, respectively correspond to, in the third and fourth external electrodes 30c and 30d, the distance from the first and second external electrode end portions to the first and second outer limit points, the width in the length direction z of the third and fourth external electrodes 30c and 30d, the distance from the first and second external electrode end portions to the first and second outer protruding portions 42a and 42b, the thickness of the first and second outer protruding portions 42a and 42b in the width direction y with respect to the first and second lateral surfaces 12c and 12d, the thickness of the middle portion 40 in the width direction y with respect to the first and second lateral surfaces 12c and 12d, the out-of-interface region glass ratio, the non-contact region glass ratio, and the like.

In addition, the outer middle portion, the first and second outer protruding portions, and the first and second outer limit points in the present modified example correspond to the middle portion, the first and second protruding portions, and the first and second limit points in the claims.
(2) In the above example embodiment, the third and fourth base electrode layers 32c and 32d each include two protruding portions. However, the third and fourth base electrode layers 32c and 32d may each include three or more protruding portions as long as it is possible to ensure a large range from the first limit point to the second limit point having a thickness of, for example, about 3 μm or more.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including a plurality of ceramic layers and a plurality of internal electrode layers that are laminated, a first main surface and a second main surface opposed to each other in a height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction; and
a plurality of external electrodes; wherein
the plurality of internal electrode layers include:
a plurality of first internal electrode layers each extending toward the first end surface and the second end surface; and
a plurality of second internal electrode layers each extending toward the first lateral surface and the second lateral surface;
the plurality of external electrodes include:
a first external electrode on the first end surface and connected to the plurality of first internal electrode layers;
a second external electrode on the second end surface and connected to the plurality of first internal electrode layers;
a third external electrode on the first lateral surface and connected to the plurality of second internal electrode layers; and
a fourth external electrode on the second lateral surface and connected to the plurality of second internal electrode layers;
the plurality of first internal electrode layers each include a first counter electrode portion opposed to a corresponding one of the plurality of second internal electrode layers, a first extension electrode portion extending from the first counter electrode portion toward the first end surface, and a second extension electrode portion extending from the first counter electrode portion toward the second end surface;
the plurality of second internal electrode layers each include a second counter electrode portion opposed to a corresponding one of the plurality of first counter electrode portions, a third extension electrode portion extending from the second counter electrode portion toward the first lateral surface, and a fourth extension electrode portion extending from the second counter electrode portion toward the second lateral surface;
in a cross-sectional view along the first main surface and the second main surface, each of the third external electrode and the fourth external electrode includes a middle portion having a thickness of about 3 μm or more in the width direction with respect to each of the first lateral surface and the second lateral surface and located at a middle in the length direction, a first protruding portion having a thickness in the width direction with respect to each of the first lateral surface and the second lateral surface larger than a thickness in the width direction of the middle portion and located closer to the first end surface than the middle portion, a second protruding portion having a thickness in the width direction with respect to each of the first lateral surface and the second lateral surface larger than a thickness in the width direction of the middle portion and located closer to the second end surface than the middle portion, a first limit point adjacent to the first end surface and having a thickness in the width direction with respect to each of the first lateral surface and the second lateral surface of about 3 μm or more from a first external electrode end portion adjacent to the first end surface, and a second limit point adjacent to the second end surface side and having a thickness in the width direction with respect to each of the first lateral surface and the second lateral surface of about 3 μm or more from a second external electrode end portion adjacent to the second end surface; and
a first extension end portion adjacent to the first end surface and a second extension end portion adjacent to the second end surface of each of the third extension electrode portion and the fourth extension electrode portion are located between the first limit point and the second limit point.

2. The three-terminal multilayer ceramic capacitor according to claim 1, wherein, in the cross-sectional view along the first main surface and the second main surface, when each of a distance from the first external electrode end portion to the first limit point and a distance from the second external electrode end portion to the second limit point is defined as f and a width in the length direction of each of the third external electrode and the fourth external electrode is defined as e, a relationship of about 0.01≤f/e≤about 0.09 is satisfied.

3. The three-terminal multilayer ceramic capacitor according to claim 1, wherein, in the cross-sectional view along the first main surface and the second main surface, when each of a distance from the first external electrode end portion to the first protruding portion and a distance from the second external electrode end portion to the second protruding portion is defined as a and a width in the length direction of each of the third external electrode and the fourth external electrode is defined as e, a relationship of about 0.10≤a/e≤about 0.30 is satisfied.

4. The three-terminal multilayer ceramic capacitor according to claim 1, wherein, in the cross-sectional view along the first main surface and the second main surface, when a thickness in the width direction of each of the first protruding portion and the second protruding portion with respect to each of the first lateral surface and the second lateral surface is defined as d, and a thickness in the width direction of the middle portion with respect to each of the first lateral surface and the second lateral surface is defined as c, a relationship of about 0.65≤c/d≤about 0.97 is satisfied.

5. The three-terminal multilayer ceramic capacitor according to claim 1, wherein, in the cross-sectional view along the first main surface and the second main surface, when a thickness in the width direction of the middle portion with respect to each of the first lateral surface and the second lateral surface is defined as c, a relationship of about 8.0 μm≤c≤about 18.0 μm is satisfied.

6. The three-terminal multilayer ceramic capacitor according to claim 1, wherein, in the cross-sectional view along the first main surface and the second main surface, when a thickness in the width direction of each of the first protruding portion and the second protruding portion with respect to each of the first lateral surface and the second lateral surface is defined as d, a relationship of about 10.0 μm≤d≤about 21.0 μm is satisfied.

7. The three-terminal multilayer ceramic capacitor according to claim 1, wherein
each of the third external electrode and the fourth external electrode includes a base electrode layer and a plated layer covering the base electrode layer; and
each of the base electrode layers of the third external electrode and the fourth external electrode includes the middle portion, the first protruding portion, and the second protruding portion, and includes the first limit point and the second limit point.

8. The three-terminal multilayer ceramic capacitor according to claim 1, wherein
each of the plurality of external electrodes includes a metal component and a glass component;
in the cross-sectional view along the first main surface and the second main surface, each of the third external electrode and the fourth external electrode includes a contact region including a contact interface in contact with each of the third extension electrode portion and the fourth extension electrode portion, and a first non-contact region located closer to the first end surface than the contact region and a second non-contact region located closer to the second end surface than to the contact region, and the first non-contact region and the second non-contact region are not in contact with each of the third extension electrode portion and the fourth extension electrode portion; and
an out-of-interface region glass ratio, which is a ratio of a glass component to a component of the third external electrode and the fourth external electrode in an out-of-interface region excluding the contact interface in the contact region, is larger than a non-contact region glass ratio, which is a ratio of a glass component to a component of the third external electrode and the fourth external electrode in each of the first non-contact region and the second non-contact region.

9. The three-terminal multilayer ceramic capacitor according to claim 8, wherein the out-of-interface region glass ratio is about 1.4 times or more and about 1.7 times or less the non-contact region glass ratio.

10. The three-terminal multilayer ceramic capacitor according to claim 8, wherein the middle portion is included in the contact region.

11. The three-terminal multilayer ceramic capacitor according to claim 1, further comprising:
an external electrode paste of the plurality of external electrodes, the external electrode paste including:
a resin;
a metal filler; and
a solvent; wherein
the solvent includes one or more first solvents and one or more second solvents;
a ratio of a mass of the first solvent to a mass of the solvent and a ratio of a mass of the second solvent to a mass of the solvent are each about 40% by mass or more;
a lowest boiling point T^{H1} among boiling points of the one or more second solvents under atmospheric pressure is higher by about 10° C. or more than a highest boiling point T^{Lh} among boiling points of the one or more first solvents under atmospheric pressure;
a highest boiling point T^{Hh} among the boiling points of the one or more second solvents under atmospheric pressure is T^{H1}+about 10° C. or less;
a lowest boiling point T^{L1} among the boiling points of the one or more first solvents under atmospheric pressure is T^{Lh}−about 10° C. or more;
the solvent includes a sub-solvent in addition to the first solvent and the second solvent;
a boiling point of the sub-solvent under atmospheric pressure is less than (T^{L1}−about 10)° C., greater than (T^{Lh}+about 10°) C and less than (T^{H1}−about 10°) C, or greater than (T^{Hh}+about 10°) C; or
the metal filler is a Cu filler; and
the resin includes an ethylcellulose-based resin and an acrylic resin, at least a portion of which is copolymerized, and an interfacial tension generated between the resin and the solvent is about 15 mN/m or more.

12. The three-terminal multilayer ceramic capacitor according to claim 1, wherein each of the plurality of ceramic layers includes BaTiO₃, CaTiO₃, SrTiO₃, or CaZrO₃ as a main component.

13. The three-terminal multilayer ceramic capacitor according to claim 12, wherein each of the plurality of ceramic layers includes a Mn compound, a Fe compound, a Cr compound, a Co compound, or a Ni compound as a subcomponent.

14. The three-terminal multilayer ceramic capacitor according to claim 1, wherein a thickness of each of the plurality of ceramic layers is about 0.3 μm or more and about 5.0 μm or less.

15. The three-terminal multilayer ceramic capacitor according to claim 1, wherein a thickness of each of the plurality of internal electrode layers is about 0.30 μm or more and about 1.0 μm or less.

16. The three-terminal multilayer ceramic capacitor according to claim 7, wherein the base electrode layer includes a fired layer.

17. The three-terminal multilayer ceramic capacitor according to claim 16, wherein the fired layer includes a glass component and a metal component.

18. The three-terminal multilayer ceramic capacitor according to claim 17, wherein the glass component includes at least one of B, Si, Ba, Mg, Al, or Li.

19. The three-terminal multilayer ceramic capacitor according to claim 17, wherein the metal component includes at least one of Ni, Ag, Pd, an Ag—Pd alloy, or Au.

20. The three-terminal multilayer ceramic capacitor according to claim 7, wherein the plated layer includes a lower plated layer including Ni and an upper plated layer including Sn on the lower plated layer.
